(19) United States
(12) Patent Application Publication
(10) Pub. No.: US 2006/0020498 A1
(43) Pub. Date: Jan. 26, 2006

(54) Asset visibility management system with rule engine

(76) Inventors: Jethender Aitipamula, Cary, IL (US); Jurgen Reinold, Palatine, IL (US); Mohsin S. Bhally, Bloomingdale, IL (US); Yang Chao, Lake Zurich, IL (US); Kathy L. Downie, Richmond, IL (US); Samuel M. Levenson, Arlington Heights, IL (US)

Correspondence Address: DONNA & WILLIAM CONN, 20306 SEABROOK DRIVE, MONTGOMERY VILLAGE, MD, 20886, US

(21) Appl. No.: 10/911,786

(22) Filed: Jul. 26, 2004

(51) Int. Cl. G06F 9/44

(52) U.S. Cl. 705/7

(57) ABSTRACT

An asset visibility management system that includes a visibility application interface, an asset data acquisition and communication device interface, and a rules engine. The visibility application interface provides communications between one of a plurality of visibility applications and a common communication format. The asset acquisition and communication device interface provides communications between a plurality of data acquisition and communication devices and the common communication format. The rules engine receives a rule criteria from the visibility application interface in the common communication format and receives visibility events from the asset data acquisition and communication device interface in the common communication format. The rules engine then uses the received visibility events to determine whether the rule criteria has been satisfied.

The present application is related to the following co-pending, commonly assigned patent applications, which were filed concurrently herewith and incorporated by reference in their entirety:

Ser. No. ______, entitled “Asset Visibility Management System,” attorney docket IS01728SAS, filed concurrently herewith.

Ser. No. ______, entitled “Scalable Asset Visibility Management System,” attorney docket IS01724SAS, filed concurrently herewith.

Ser. No. ______, entitled “Asset Visibility Management System with Binding and Unbinding of Assets,” attorney docket IS01727SAS, filed concurrently herewith.

Ser. No. ______, entitled “Asset Visibility System with Event Correlator,” attorney docket IS01725SAS, filed concurrently herewith.

### FIELD OF THE INVENTION

This invention in general relates to managing assets across different domains and, more particularly, to a visibility management system a rule engine that allows for the management and visibility of the assets across different domains.

### BACKGROUND OF THE INVENTION

There are many independent business entities that facilitate the movement of an asset, whether a product, device, or component of a product/device, from a manufacturer to a retailer. The work flow may include multiple entities such as transportation companies (e.g., truck, ship, and rail), transfer companies (e.g., docks and rail yards), and storage and distribution companies.

Today, each entity or facility may have their own tracking or management system that is unique to the services that the entity or facility provides. For instance, a transport company may have a specific transport management system that tracks vehicles by exchanging data messages over a cellular network. The data messages may include reports to the transport facility on the location of the vehicles. Another transport company, owned by a different entity, may use satellite communications to communicate with their company owned vehicles. In the same asset distribution chain, a storage facility owned by a different entity may track an asset using radio frequency identification tags or bar code scanners. While other facilities, such as a dock or other transfer company, may simply track assets coming in and out of their facility through manually-entered shipping paperwork.

A need exist for a system that provides visibility and management of an asset across many different types of systems in different types of domains. This type of system needs to handle, process, and escalate a number of real time events that are generated by different entities. Such a system would improve communications between different business entities and help independent business entities operate with improved efficiency.

It is, therefore, desirable to provide a system and method to overcome or minimize most, if not all, of the preceding problems especially in the area of asset visibility and management across different domains.

### BRIEF DESCRIPTION OF THE DRAWINGS

FIG. 1 is a block diagram of one embodiment of an asset visibility management system according to the present invention;

FIG. 2 is a block diagram of a local asset visibility system of an originator facility that is connected to the asset visibility system of the present invention;

FIG. 3 is a block diagram of a local asset visibility system of a transport facility that is connected to the asset visibility system of the present invention;

FIG. 4 is a block diagram of a local asset visibility system of a transfer facility that is connected to the asset visibility system of the present invention;

FIG. 5 is a block diagram of a local asset visibility system of another transport facility that is connected to the asset visibility system of the present invention;

FIG. 6 is a block diagram of a local asset visibility system of a storage facility that is connected to the asset visibility system of the present invention;

FIG. 7 is a block diagram of a local asset visibility system of a recipient facility that is connected to the asset visibility system of the present invention;

FIG. 8 is a block diagram of one embodiment of a data message exchange system in the asset visibility management system of the present invention;

FIG. 9 is a diagram illustrating one embodiment of a format for a central database that tracks the status of assets within a distribution chain;

FIG. 10 is a block diagram of another embodiment of a data message exchange system in the asset visibility management system of the present invention;

FIG. 11 is a diagram illustrating another embodiment of a format for a central database that tracks the identification of information about assets within a distribution chain;

FIG. 12 is a block diagram of a further embodiment of a data message exchange system in the asset visibility management system of the present invention;

FIG. 13 is a block diagram of a system architecture of the asset visibility management system of the present invention;

FIG. 14 is a block diagram of one embodiment of categorizations for data acquisition and communication devices in the asset visibility management system;

FIG. 15 is a block diagram of an example of binding and unbinding of assets within the asset visibility management system;

FIGS. 16-18 are diagrams illustrating one embodiment of the binding of assets within the asset visibility management system;

FIG. 19 is a diagram illustrating another embodiment of the binding of assets within the asset visibility management system;

FIGS. 20-21 are flow diagrams that illustrate one embodiment of steps in a method for binding and unbinding assets;

FIG. 22 is a flow diagram that illustrates one embodiment of steps for retrieving information on the status of an asset that may be bound to higher level asset carriers;

FIGS. 23-24 are block diagrams that illustrate one embodiment of an asset visibility management system having an event correlator;

FIG. 25 is a flow diagram that illustrates a method using the event correlator in FIG. 23;

FIGS. 26, 27 and 29 are diagrams illustrating embodiments of formats for the event correlator in FIG. 23;

FIG. 28 is another flow diagram that illustrates another method using the event correlator in FIG. 23;

FIG. 30 is a block diagram illustrating one embodiment of a visibility management system having a rules engine;

FIG. 31 is a flow diagram that illustrates a method for using the rules engine in FIG. 30; and

FIG. 32 is a diagram illustrating one embodiment of a database for the rules engine in FIG. 30.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

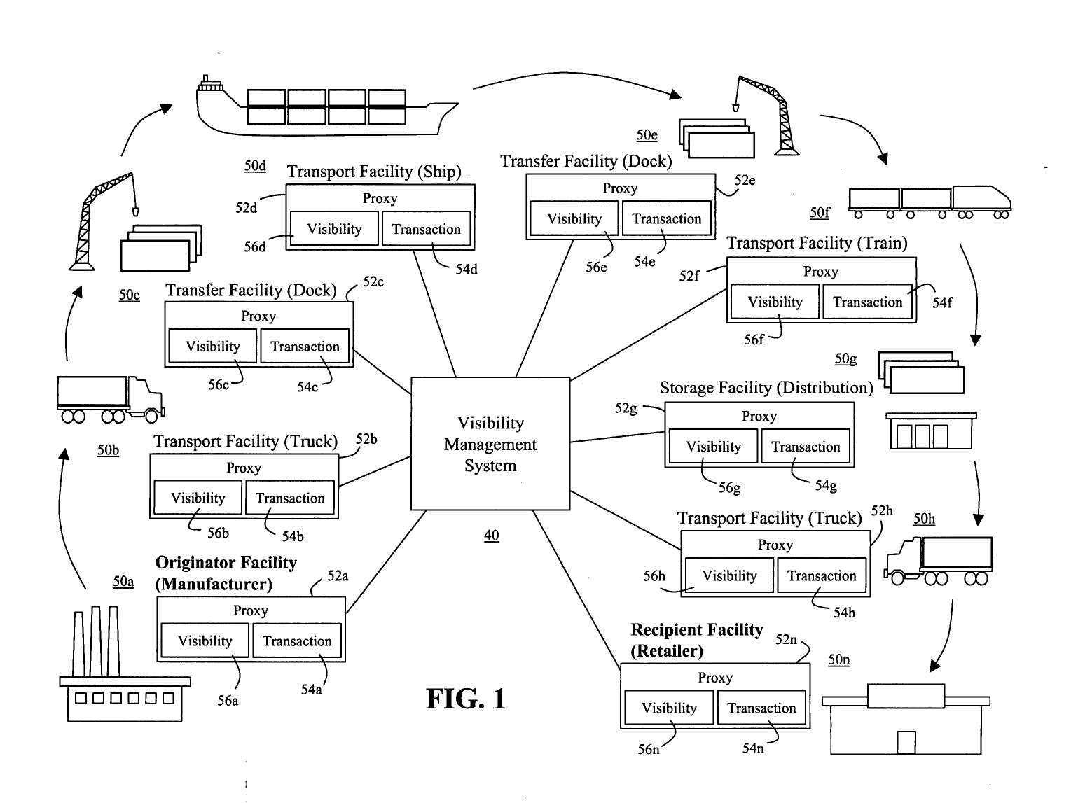

FIG. 1 illustrates a top-level block diagram of one embodiment of a visibility management system 40. The visibility management system 40 comprises of a plurality of proxies that are interconnected over a common communication protocol. Each proxy is associated with a facility that handles an asset as the asset moves from an originating facility 50a to a recipient facility 50n. For purposes of illustration, FIG. 1 shows an originating facility 50a as a manufacturing facility that makes or creates an asset. The recipient facility 50n is shown as a public retailer of the asset. The originating facility 50a and recipient facility 50n are not limited to manufacturing and retailing facilities but may serve other purposes and functions along an asset distribution chain.

Nevertheless, an asset may move from an originating facility 50a to a recipient facility 50n in a variety of ways. For purposes of illustrating the advantages and benefits of the present invention, FIG. 1 shows one way that an asset may move from an originating facility 50a to a recipient facility 50n. Here, an asset may move between different types of transport facilities 50b, 50d, 50f, 50h, transfer facilities 50c, 50e, and storage facilities 50g. Although a specific set of transport, transfer, and storage facilities is shown for purposes of illustration, one skilled in the art having the benefit of this disclosure will recognize that aspects of the facilities, and functions thereof, may be combined, swapped, added, or subtracted. What is important to note is that each facility may use their own local asset management system. One aspect of the present invention is to provide a mechanism for tying local asset management systems together to provide an end-to-end solution for asset visibility management.

In this illustrative case, after the asset is manufactured at the originator facility 50a, the asset may be grouped with other assets on a pallet and then placed into a container. The container may then be attached to a truck that is owned by a first transport facility 50b. The first transport facility 50b takes custody of the asset and may be responsible for moving the container (that holds the asset) from the originator facility 50a to a first transfer facility 50c, such as a shipping dock.

At the first transfer facility 50c, the container (that holds the asset) may be taken off the truck and temporarily held at the first transfer facility 50c. When available, the first transfer facility 50c may transfer the container to another transport means, such as a ship, that is owned by a second transport facility 50d.

The second transport facility 50d takes custody of the container (that holds the asset) and, in one embodiment, may be responsible for moving the container from the first transfer facility 50c to a second transfer facility 50e. Here, the second transfer facility 50e may then transfer the container to another transport means, such as a train, that is owned by a third transport facility 50f.

The third transport facility 50f takes custody of the container (that holds the asset) and may be responsible for moving the container from the second transfer facility 50e to a storage facility 50g, such as a distribution facility. The storage facility 50g may hold the container until a fourth transport facility 50h picks up the container. The storage facility 50g may also unload the container and move the asset to a different container that is associated with a number of other assets that are intended for the recipient facility 50n.

The fourth transport facility 50h takes custody of the container (that holds the asset) and may be responsible for moving the container from the storage facility 50g to the recipient facility 50n. There, the recipient facility 50 n may take custody of the asset and may provide the asset for sale to the general public.

A need exists for individuals and entities along the distribution chain to have visibility of the asset as it moves from the originating facility 50a to the recipient facility 50n. The asset may be a component of a product or device, a product or device itself, or an assembly of products/devices or components grouped together in a package. Today, each facility may have its own asset tracking or management system that is unique to the services that the facility provides. For instance, the first transport facility 50b may have a specific transport asset management system that is different from the transport asset management system used by the second, third and fourth transport facilities 50d, 50f, 50h. Similarly, the transfer facility 50b may have its own asset management system that is different from any system used by the recipient facility 50n. The present invention advantageously provides for the visibility and management of an asset as the asset moves from the originating facility 50a to the recipient facility 50n. For the recipient, this visibility and management provides valuable input for stocking store shelves and placing better orders. For transportation facilities and storage facilities, this visibility and management provides for better allocation of assets and ensures that facilities have adequate resources to keep the asset moving efficiently through the distribution chain.

As mentioned above, the visibility management system 40 of the present invention comprises of a plurality of proxies 52a-n that are interconnected over a common communication protocol. Each proxy may have a transaction component 54a-n and a visibility component 56a-n. These components allow the proxy 52a-n to convert or translate information between a local asset management system and a common information model that can be shared with other proxies 52a-n.

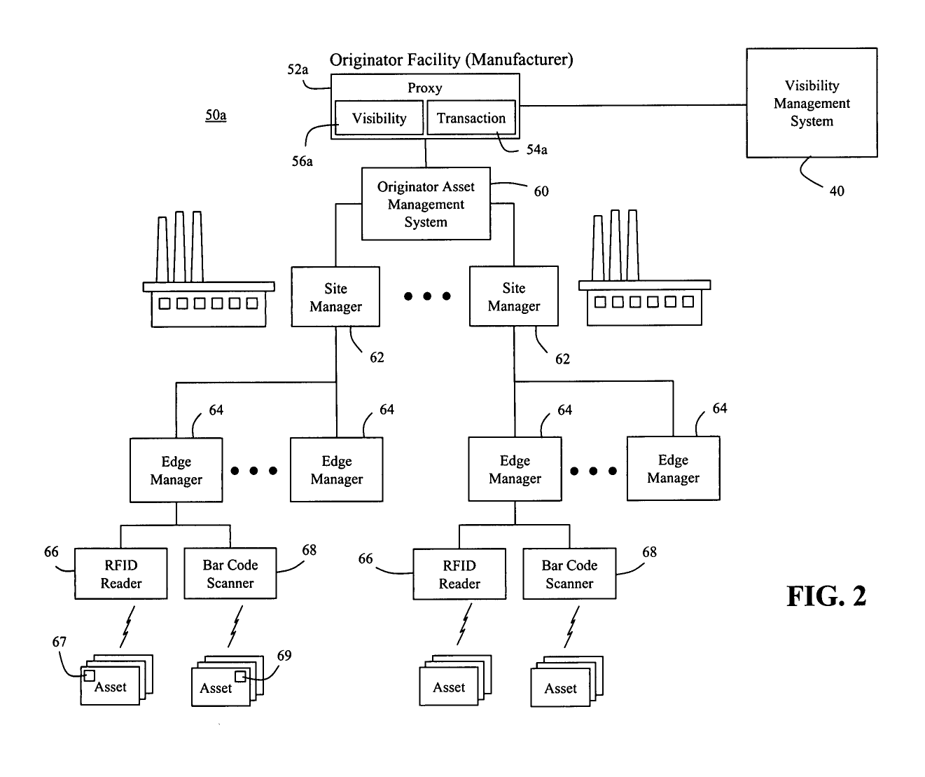

FIGS. 2-7 illustrate some of the different types of local asset management systems that may exist at facilities and how they may be connected to the visibility management system 40. For instance, FIG. 2 illustrates an example originating proxy 52a associated with an originator facility 50a that is responsible for making or creating an asset. The originating proxy 52a may comprise a transaction component 54a and a visibility component 54b. The originating proxy 52a is attached to a local originator asset management 60 The local originator asset management system 60 may include a transaction system such as an Enterprise Resource Planning (ERP) system or a Manufacturing Execution System (MES) and a data acquisition and communication systems. These types of systems, and others, are explained in more detail below. Although the originator may use a variety of different types of asset management systems 60, FIG. 2 illustrates one embodiment where the originator asset management system has a plurality of site managers 62 that each manages assets for a specific manufacturing facility. Each site manager 62 may be connected to a plurality of edge managers 64 that are located throughout a facility to manage and track assets. For example, an edge manager 64 may comprise a plurality of data acquisition and communication devices such as a RFID reader 66 or a bar code scanner 68. The asset acquisition and communication devices gather information on assets within the facility such as tracking the location of assets.

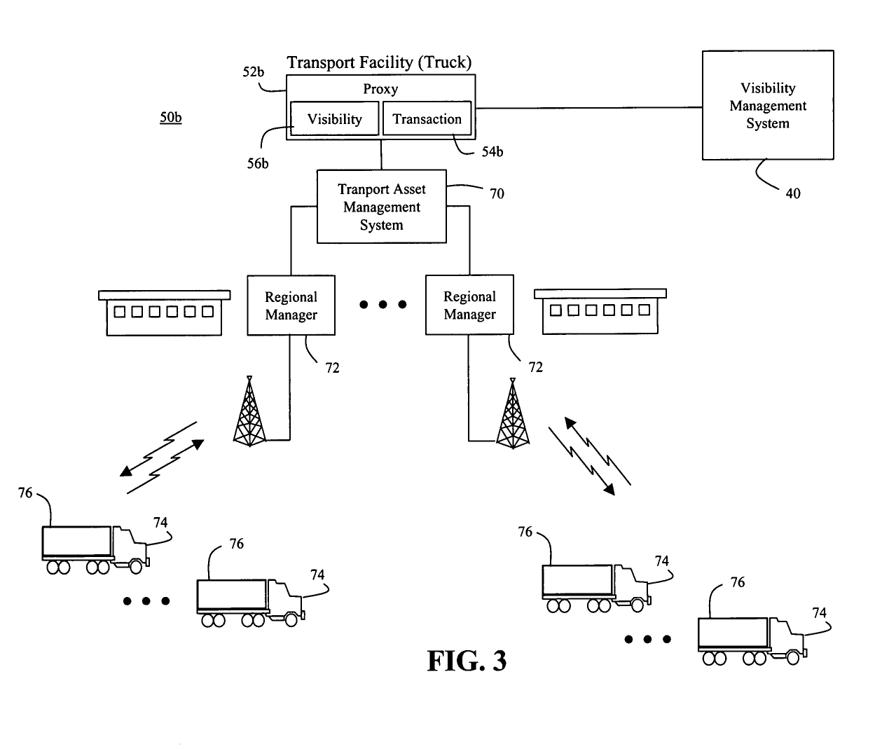

FIG. 3 illustrates an example proxy 52b associated with a transport facility 50b that is responsible for moving an asset from one location to another location. The proxy 52b associated with this transport facility 50b may comprise a transaction component 54b and a visibility component 56b. This proxy 52b may also be attached to a local transport asset management system 70, such as a Transport Management System (TMS). This system, and others, is described in more detail below. The transport asset management system 70 may be connected to one or more regional managers 72 that monitor the movement of vehicles 74 (here, trucks) within its transport fleet. In one embodiment, the vehicles 74 owned by the transport facility 50b may have GPS receivers or other location type devices that allow the vehicles 74 to report their location to a regional manager 72. The vehicles 74 may also report other data such as temperature, humidity, and acceleration of any containers 76 being carried by the vehicle 74. The vehicles 74 may report this information through wireless communication systems such as a cellular or a satellite network.

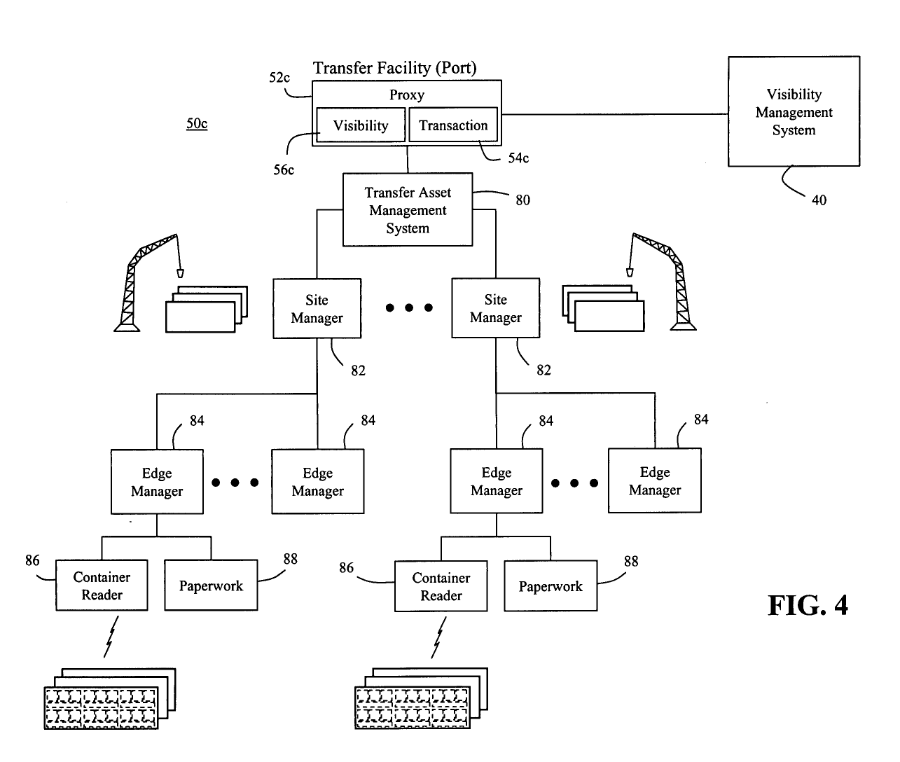

FIG. 4 illustrates an example proxy 52c associated with a transfer facility 50c that is responsible for transferring an asset from one facility or entity to another facility or entity. Here, the proxy 52c may also contain a transaction component 54c and a visibility component 56c. The proxy 52c is also attached to a local transfer asset management system 80 that monitors and schedules the transfer of containers (that holds the assets). In one embodiment, shown for illustration purposes only, the transfer asset management system 80 may have one or more site managers 82 that manage the transfer of assets at a specific site. The site managers 82 may be connected to one or more edge managers 84 that monitor and track the input and output of containers at the site. The edge managers 84 may comprise a variety of asset acquisition devices such as a container reader 86. The edge manager 84 may also be provided with manually entered data from shipping paperwork 88 associated with a container.

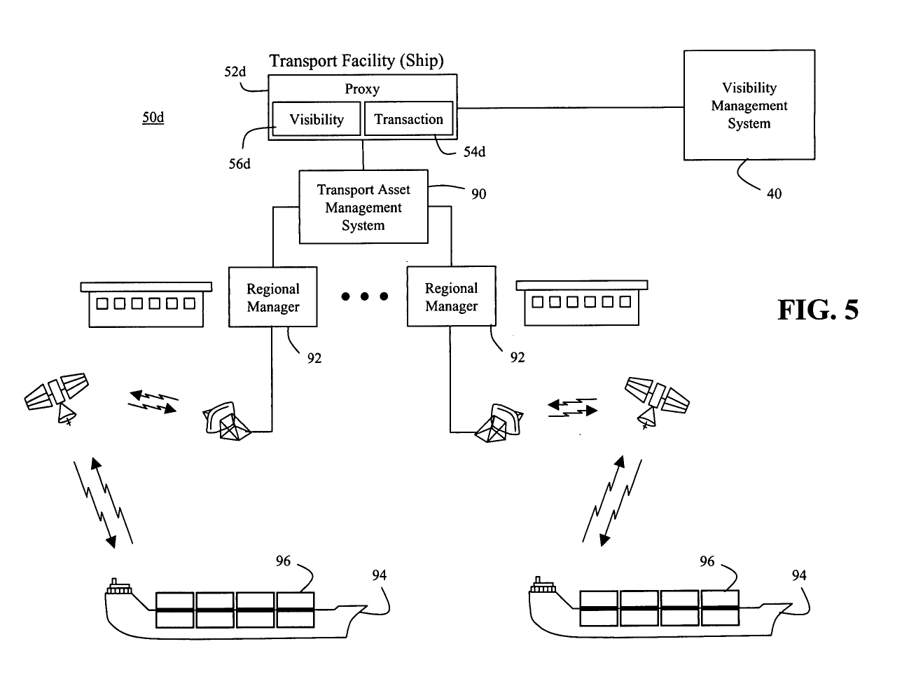

FIG. 5 illustrates an example proxy 52d that is associated with another transport facility 50d that is responsible for moving an asset from one location to another location. The proxy 52d here may also contain a transaction component 54d and a visibility component 56d. The proxy 52d may also be attached to a local transport asset management system 90 which, in turn, is connected to one or more regional managers 92. The regional managers 92 may monitor the movement of vehicles 94 (here, ships) within its transport fleet. In one embodiment, the vehicles 94 owned by the transport facility 50d may have GPS receivers or other satellite location devices that allow the vehicles 94 to report their location to the regional manager 92. The vehicles 94 may also report other data such as temperature, humidity, and acceleration of any containers 96 being carried by the vehicle 94. The vehicles 94 may report their location and other data to the regional manager through wireless communication systems such as a satellite network.

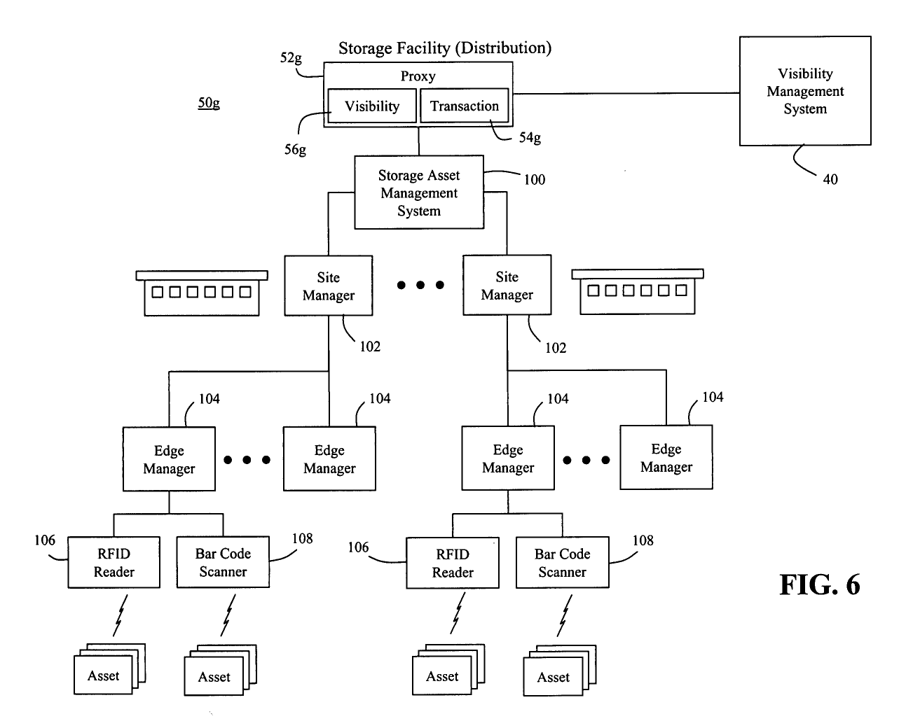

FIG. 6 illustrates an example proxy 52g that is associated with a storage facility 50g that is responsible for storing assets before sending an asset to the recipient facility 50n. The storage facility 50g may also serve as a distribution point that disassembles containers of assets and regroups the assets for final shipment to a recipient facility 50n. In any event, the proxy 52g associated with the storage facility 50g may also have a transaction component 54g and a visibility component 56g. The proxy 52g may also be attached to a local storage or distribution asset management system 100. The local storage or distribution asset management system 100 may comprise a Warehouse Management System (WMS) or a Data Warehouse System (DWS). These and other systems are described in more detail below. The local storage or distribution asset management system 100 may also include one or more regional site managers 102 that are associated with a specific distribution facility or warehouse. The site managers may be connected to one or more edge managers 104 that individually monitor and track the movement of containers and assets within the custody of the storage facility 50g. For example, an edge manager 104 may comprise a plurality of asset acquisition and communication devices such as a RFID reader 106 or a bar code scanner 108.

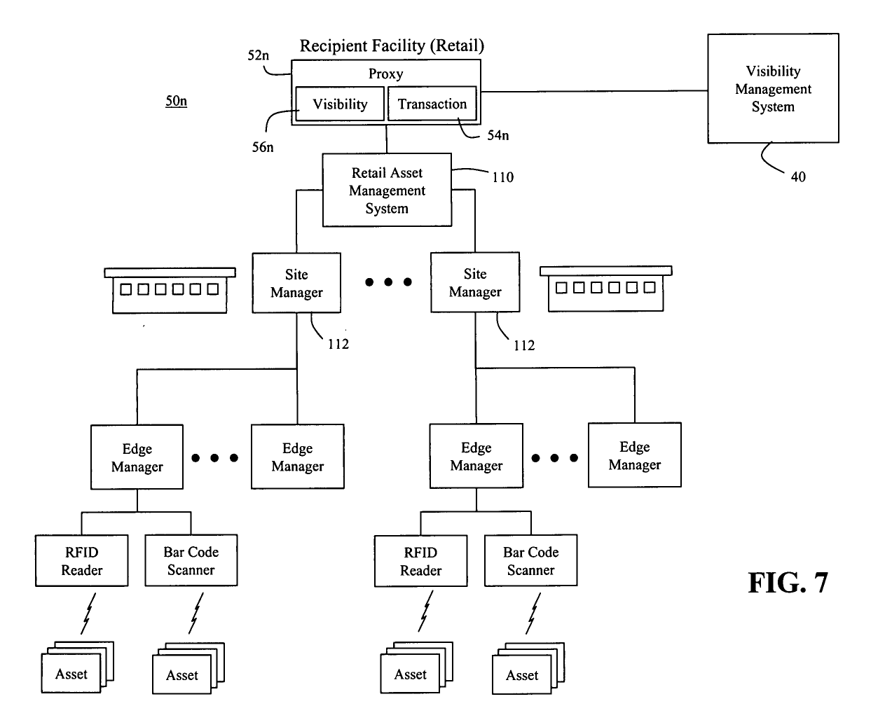

FIG. 7 illustrates an example recipient proxy 52n that is associated with a storage facility 50n that eventually receives the asset and provides the asset for sale to the general public. The recipient proxy 52n may also comprise a transactional component 54n and a visibility component 56n. The recipient proxy 50n may also have their own local retail asset management system 110 for ordering and monitoring inventory levels at the retail stores owned by the recipient. For instance, the local retail asset management system 110 may be connected to one or more site managers 112 that are placed at specific retail outlets. Each site manager 112 may be responsible for monitoring and tracking the movement of assets in a backroom and on shelves of the retail outlet.

One skilled in the art having the benefit of this disclosure will recognize that specific aspects of the above-described local asset management systems for the various facilities can have a number of differing and overlapping layers to track and manage assets and asset carriers. Each system will be implementation specific to the purposes of the entity or facility.

Common Communication Protocol

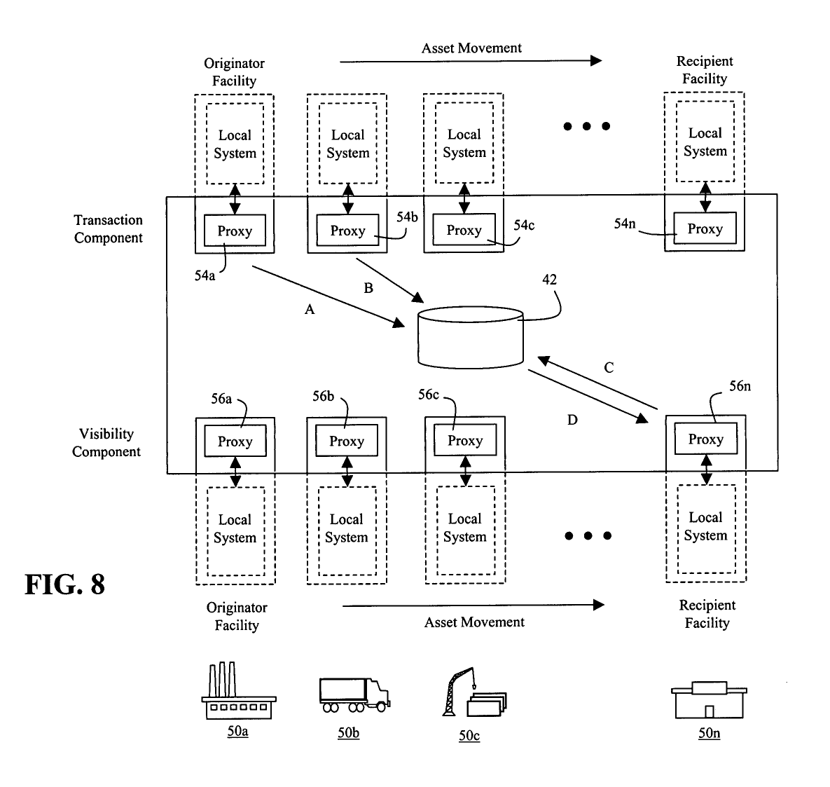

FIGS. 8-12 illustrate different types of configurations for exchanging asset state information between the proxies 52a-n. In a first embodiment, as illustrated in FIG. 8, the visibility management system 40 includes a functional or logical central database 42 that is connected to each proxy. The central database 42 may reside at a central service facility that facilitates the common communication protocol between the proxies or could be part of a distributed system. As mentioned above, each proxy may have a transaction component 54a-n and a visibility component 56a-n. The transaction component 54a-n of each proxy is represented in the upper boxes of FIG. 8. The visibility component 56a-n of each proxy is represented in the lower boxes of FIG. 8.

In the embodiment shown in FIG. 8, the central database 42 maintains all current and historical information about the state of an asset as it moves from an originator facility 50a to a recipient facility 50n. As the custody of the asset moves from one facility to another facility, the transaction component of that facility will send data messages to the central database 42 to inform the central database 42 that an event has occurred and any details associated with the event. For example, the originator facility 50a may register an asset by sending a data message (arrow A) to the central database 42. This data message may include the identification of the event (e.g., asset registration) and details associated with the event (e.g., asset identification, asset description, asset location). The transaction component 54a of the proxy 52a may be responsible for generating the data messages to the central database 42.

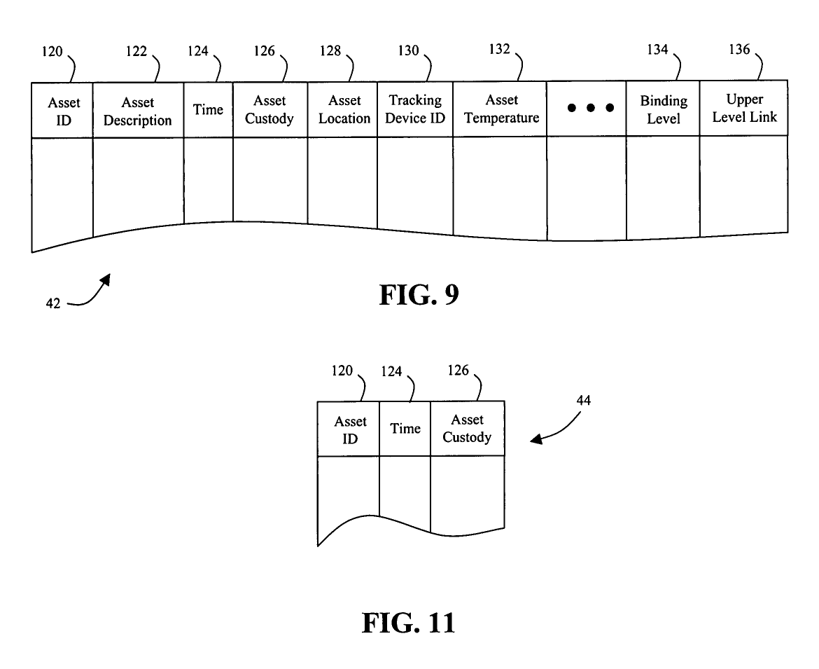

Referring to FIG. 9, for each registered asset, the central database 42 may store a plurality of information elements or fields such as an asset identification 120, an asset description 122, a 124 that the information elements or fields were last updated, an asset custody identification 126, an asset location 128, a tracking device identification 130, and other environmental conditions, if needed, such as an asset temperature 132. Other information elements or fields that may be included, for enhancing functionality, include a binding level 134 and an upper blinding level link 136. Binding levels and binding level links will be discussed in more detail below.

In turn, referring back to FIG. 8, a transport facility 50b may send a data message (arrow B) when it takes over custody of the asset. This data message may include the identification of the event (e.g, custody change) and the details associated with the event (new custody identification, new asset location, new asset binding level). Thereafter, the transport facility 50b may be scheduled to send additional periodic data messages to update the status of an asset (e.g., new location, new environmental conditions, etc.). The transaction component 54b of the proxy 50b may be responsible for generating the data messages to the central database 42.

The visibility component 56a-n of each proxy 52a-n enables a user to access the central database 42 and obtain information regarding the status of assets that are moving from the originator facility 50a to the recipient facility 50n. For instance, the recipient facility 50n may want to check that status of an asset that they expect will be delivered to their facility. The visibility component 56n will generate and send a query data message (arrow C) to the central database 42 inquiring about the status of an asset. The visibility management system 40 will then generate and send a response data message (arrow D) to the visibility component 56n of the querying proxy 52n. The information contained in the response data message may be obtained from the central database 42.

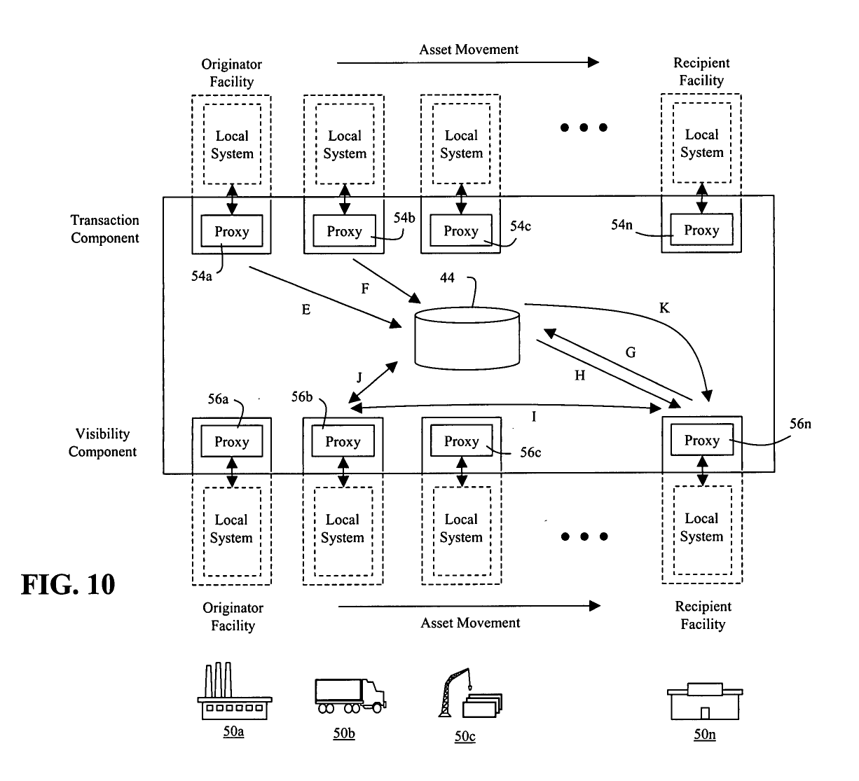

In a second embodiment, as illustrated in FIG. 10, the visibility management system also includes a central database 44 that is connected to each proxy 52a-n. However, in this embodiment, the central database 44 does not maintain all current and historical information about the state of an asset. Instead, each proxy 52a-n maintains the state of the asset as it moves along the distribution chain. Although either the transaction component or the visibility component may store state information, for purposes of illustration, it will be assumed that the state information is stored in the visibility component of each proxy. The central database 44 stores information relating to the identification of proxies that contain the state of the asset. In other words, when a query is made to the central database 44 for the state of an asset, the central database 44 will respond with the identification of the proxy who has the best information on the state of the asset.

For instance, in the second embodiment, as the custody of the asset moves from one facility to another facility, the transaction component of that facility will send data messages to the central database 44 to inform the central database 44 that a custody change has occurred and the identity of the new custody entity. For example, the originator facility 50a may register an asset by sending a data message (arrow E) to the central database 44. This data message would include the identification of the event (e.g., asset registration) and custody owner (e.g., originator facility 50a). The transactional component 54a of the proxy 52a may be responsible for generating the data message to the central database 44.

Referring to FIG. 11, for each registered asset, the central database 44 would simply store the asset identification 120, a time 124 that the information elements or fields were last updated, and an asset custody identification 126.

In turn, referring back to FIG. 10, a transport facility 50b may send a data message (arrow F) when it takes over custody of the asset. This data message may include the identification of an event (e.g., custody change) and the details associated with the event (new custody identification). The transaction component 54b of the proxy 52b may be responsible for generating the data message to the central database 44.

The visibility component 56a-n of the proxy 52a-n enables a user to access the central database 44 and obtain information so that the user may then contact the correct proxy to obtain the status of an asset. For instance, the recipient facility 50n may want to check the status of an asset that they expect will be delivered to their facility. The visibility component 56n will generate and send a query data message (arrow G) to the central database 44 inquiring about the status of an asset. In one embodiment, the visibility management system 40 will then generate and send a response data message (arrow H) to the visibility component 56n of the querying proxy 52n. The response data message may include information on the identification of the proxy associated with the facility that has custody over the asset. The visibility component 56n may then exchange data messages (arrows I) to the proxy that has the latest state information on the asset. Alternatively, the visibility management system 40 may have a central function that may gather information from the proxy that has the latest state information on the asset (arrows J) and return the state information in a data message to the querying proxy 56n (arrow K).

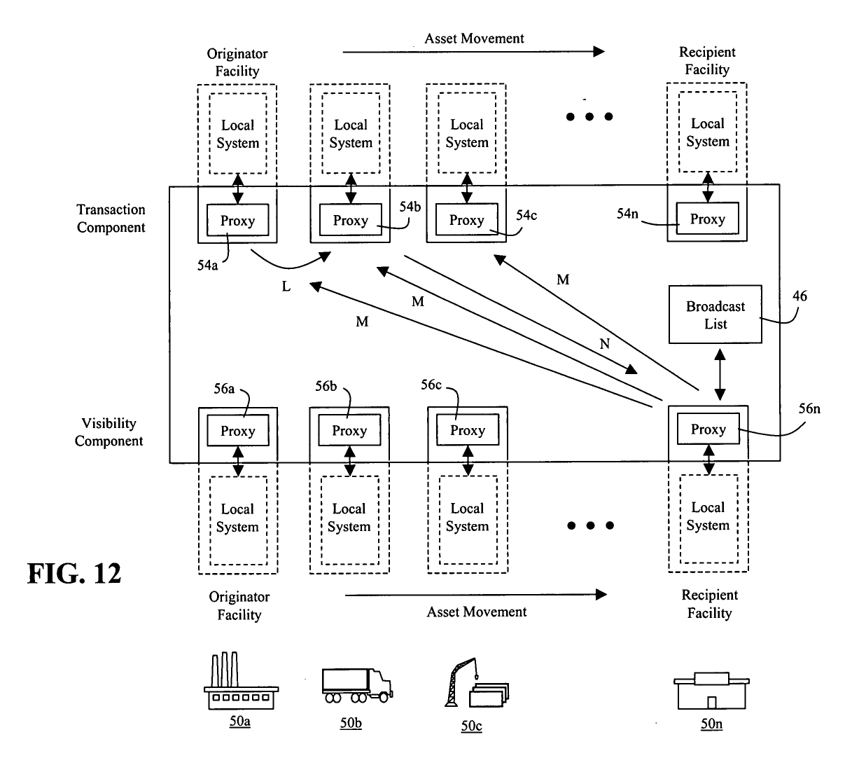

In a third embodiment, as illustrated in FIG. 12, the visibility management system 40 does not have a central database. Instead, each proxy 52a-n maintains the state of the asset as it moves along the distribution chain. Although either the transaction component or the visibility component may store state information, for purposes of illustration, it will be assumed that the state information is stored in the transaction component of each proxy. In this case, when a query is made regarding the state of an asset, the visibility component of a proxy will broadcast a message with the identification of the asset and ask for a response from the proxy that has current custody of the asset.

For instance, in the third embodiment, as the custody of the asset moves from one facility to another facility, the transaction component of that facility will store information relating to whether or not the facility has custody over the asset. For example, the originator facility 50a may initialize an asset by setting up a plurality of information elements or fields similar to the one shown in FIG. 9. Instead of storing the information at a central database, the information is stored in the transaction component of the proxy.

In turn, referring back to FIG. 12, a transport facility 50b may receive a data message (arrow L) when it takes over custody of the asset. This data message may include an asset identification, an asset description, a time that the information elements or fields were last updated, an asset location, an asset custody identification, a tracking device identification, and other environmental conditions, if needed, such as an asset temperature. Other information elements or fields that may be included, for enhancing functionality, include a binding level and an upper blinding level link. Binding levels and binding level links will be discussed in more detail below.

The visibility component 56a-n of the proxy 52a-n enables a user to access other transaction components 54a-n of other proxies by broadcasting a message when a user desires to learn the state of an asset. For instance, the recipient facility 50n may want to check the status of an asset that they expect will be delivered to their facility. The visibility component 56n will generate and broadcast a query data message (arrows M) to all proxies inquiring about the status of an asset. The proxy associated with the current custody owner of the asset will gather responsive information and transmit the information back to the querying proxy 56n (arrow N).

In one embodiment, the identification of proxies 52a-n to include in the broadcast may be obtained from a broadcast list 46. The broadcast list 46 may include a directory of addresses that should be included for requesting information about an asset. The broadcast list 46 may be statically configured or may be dynamic with other entities registering their need for inclusion on the broadcast list 46. This directory may be centralized or distributed among the proxies 52a-n. The proxies 52a-n may either access this list and directly broadcast request or send the request to some central broadcast function which will have access to the lists to perform the broadcast function.

FIGS. 8-12 illustrate different types of exemplary configurations within the framework of the present invention. Although specific types of configurations are shown, the features and functions of these configurations may be combined or swapped depending on the complexity of the system and the type of distribution chain implemented with the movement of a particular asset.

System Architecture

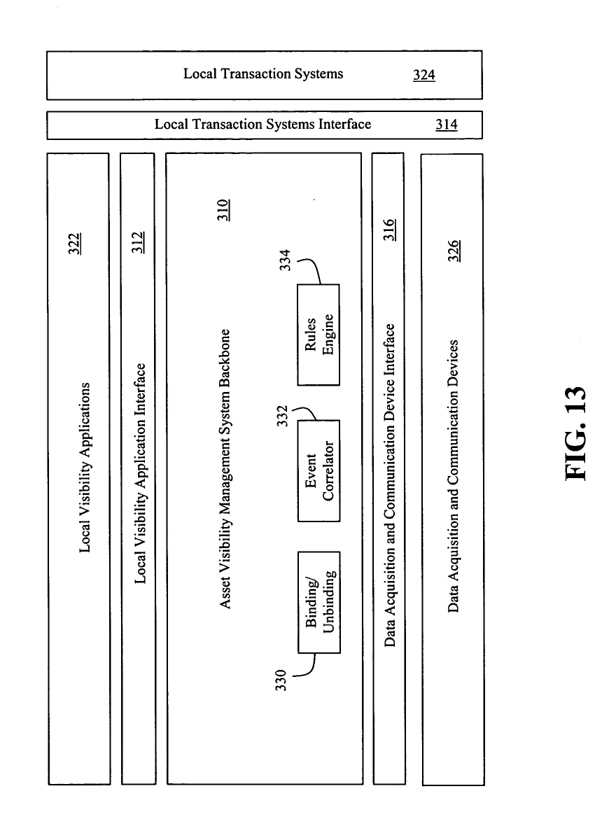

A need exists to have an overall asset visibility management system that is designed to work with a multitude of existing technologies as well as emerging and future technologies. The asset visibility management system 40 advantageously satisfies this need by having a system architecture that is designed to handle a variety of technologies. FIG. 13 illustrates one embodiment of a system architecture for the asset visibility management system 40.

The core components of the system architecture are an asset visibility management system backbone 310, a local visibility application interface 312, a local transaction system interface 314, and a data acquisition and communication device interface 316. The asset visibility management system backbone 310 provides the correlation between systems in a secure, intelligent, efficient, reliable and timely manner. The backbone 310 also provides seamless interfaces between local visibility applications 322, local transaction systems 324, and data acquisition and communication devices 326. This is achieved by a variety of functions such as a binding and unbinding function 330, an event correlation function 332, and a rules engine function 334. These functions are described further below.

The local visibility application interface 312 provides an interface between the backbone 310 and the local visibility applications 322. The local visibility applications 322 consist of off-the-shelf applications and customized applications built by third parties to provide asset visibility within their facilities. The local visibility applications 322 include the user interface for tracking and managing assets and asset carriers. The type of application will be implementation specific and depend on the visibility and functions needed by a specific entity or facility.

The local transaction system interface 314 provides an interface between the backbone 310 and the local transaction systems 324. The local transaction systems 324 may consist of a wide variety of existing business transaction management systems including an Enterprise Resource Planning (ERP) system, a Warehouse Management System (WMS), a Yard Management System (YMS), a Manufacturing Execution System (MES), a Transportation Management System (TMS), or a Supply Chain Management (SCM) system.

An ERP is an industry term for the broad set of activities supported by multi-module application software that helps a manufacturer or other business manage the important parts of their business, including product planning, parts purchasing, maintaining inventories, interacting with suppliers, providing customer service, and tracking orders. ERP can also include application modules for the finance and human resource aspects of a business.

A WMS is a system that manages the inventory-handling and its surrounding processes in the warehouse, including light manufacturing, transportation management, order management, and complete accounting systems.

A YMS is a system that treats the distribution center yard as an extension of the warehouse. It manages the inbound, outbound shipments as well as the inventory in the yard to improve the efficiency between a yard gate and a dock door.

A MES is a term for software systems designed to integrate with enterprise systems to enhance the shop floor control functionality that is usually inadequate in ERP systems. MES provides for shop floor scheduling, production and labor reporting, integration with computerized manufacturing systems such as automatic data collection and computerized machinery.

A TMS is a system that performs transportation functions such as optimizing transportation loads, plans routes, and tracks the shipments of assets on its fleet of vehicles.

A SCM refers to a system that attempts to coordinate processes involved in producing, shipping and distributing products, generally performed only by large corporations with large suppliers.

The data acquisition and communication interface 316 provides an interface between the backbone 310 and data acquisition and communication devices 326. A facility (such as an originator facility, a transport facility, a transfer facility, a storage facility, or a recipient facility) may use a variety of data acquisition and communication devices 326 within their business to manage assets within their facility. For instance, referring to FIG. 2, an originator facility 50a may use Radio Frequency Identification (RFID) technology. RFID refers to technology that uses tags 67 attached to assets that exchange data with a RFID reader 66 for tracking purposes. The RFID reader 66 typically has an antenna or coil that emits radio signals to activate the tag 67 in order to read and write data. The RFID reader 66 may then communicate over a wired or wireless connection with different managers (such as an edge manager 64 or site manager 62) within the originator's asset management system 60. Wireless connections within the asset management system 60 may include an IEEE 802.11 communication system or a Canopy™ system.

In addition to RFID technology, an originator facility 50a may also use bar code technology to track assets within its custody. Here, a bar code 69 may be placed on an asset and may be read by a bar code scanner on an assembly line or by a portable handheld scanner. Other facilities may also use RFID technology and bar code technology such as the ones shown in FIGS. 6 and 7.

Referring to FIGS. 3 and 5, when an asset (within a container) is loaded on a vehicle (such as a truck, ship or train), a transport facility 50c, 50d may be independently tracking information regarding the location and status of vehicles 74, 94 within their fleet or domain. A combination of wireless networks (cellular or satellite) may be used to transfer information between the vehicles 74, 94 and a transport asset management system 70, 90. For instance, a GPS receiver or other location type unit may be located in the vehicle 74, 94 to report a location to the transport asset management system 70, 90. Some transport facilities may also gather and track additional data such as the temperature, humidity, and acceleration of any containers 76, 96 that are located on the vehicle 74, 94.

Referring to FIG. 4, when an asset is loaded within a container, such as when it is being held at a transfer facility 50c, the facility may be independently tracking information regarding the location and status of containers within their custody. In some cases, the facility may use fixed or portable container readers 86 that utilize RFID or bar code technology to track the movement and location of containers. In other cases, the facility may track containers by data entered by employees from paperwork 88 that is associated with a container.

In one embodiment of the present invention, the asset visibility management system 40 is configured so that it is scalable with a variety of data acquisition and communication devices 326. Accordingly, each of the data acquisition and communication devices 326 used within the system are assigned to one or more predefined categories when interfacing with the asset visibility management system backbone 310.

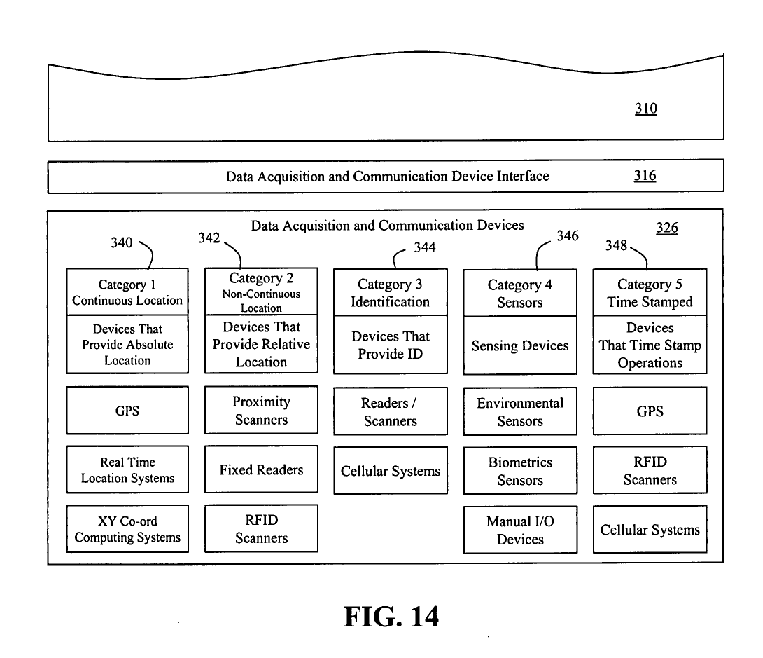

Referring to FIG. 14, in one embodiment, the predefined categories may include a substantially continuous location category 340, a substantially non-continuous location category 342, an identification category 344, a sensor category 346, and a time stamp category 348. The main characteristic of the substantially continuous location category 340 is where a data acquisition and communication device 326 is capable of reporting a precise location in absolute terms. In other words, any device or subsystem that keeps track of real time location of an asset or asset carrier on a substantially continuous basis may fall within this category. Accordingly, any data acquisition and communication device 326 that is capable of substantially reporting an absolute location would be assigned to at least the continuous location category 340. An example of a data acquisition and communication device 326 that may fall within this category is a GPS receiver attached to vehicle. Another example of a data acquisition and communication device 326 that may fall within this category is a real time location system such as a dead-reckoning system or a XY co-ord computing system that derives an absolute location via techniques such as triangulation.

In an alternative embodiment, the substantially continuous location category 340 may be further sub-divided into the following sub-categories: periodic and queried. The division of these sub-categories is based on how the location data is retrieved by the visibility management system 40. The periodic sub-category refers to a data acquisition and communication device 326 that periodically reports a location to the visibility management system 40. The queried sub-category refers to a data acquisition and communication device 326 that requires the visibility management system to query the device to retrieve any location data.

The main characteristic of the substantially non-continuous location category 342 is where a data acquisition and communication device 326 is capable of substantially reporting a general location such as whether an asset is “seen” in the presence or within the range of a scanner or reader. Here, location information of an asset may be computed either directly with reference to the location of the data acquisition and communication device 326 or indirectly (such as extrapolated). The location of the data acquisition and communication device 326 may either be reported by the device itself or may be pre-configured in the system in the case of fixed devices. An example of a data acquisition and communication device 326 that may be assigned to this category is a proximity scanner, a fixed reader, or an RFID scanner. For instance, a facility may have a fixed barcode reader placed at a docking door of a warehouse. As soon as the asset moves through the docking door, the reader may scan a bar code that is interpreted by the system as being within the presence or range of the fixed barcode reader.

In an alternative embodiment, the substantially non-continuous location category 342 may be further sub-divided into the following sub-categories: periodic and event-driven. The division of these sub-categories is based on how the location data is retrieved by the visibility management system 40. The periodic sub-category refers to a data acquisition and communication device 326 that periodically communicates with the visibility management system 40 whether or not an asset movement has been detected. The event-driven sub-category refers to a data acquisition and communication device 326 that reports data to the visibility management system 40 every time an event occurs, such as the sensing of the movement of an asset.

The main characteristic of the identification category 344 is where a data acquisition and communication device 326 is capable of reporting a unique identifier of an asset. For example, a GPS receiver that is assigned to the continuous location category 340 may also be assigned to the identification category 344 if the GPS receiver is capable of communicating a unique identifier that differentiates it from other devices in the system. The identification category 344 has the benefit of helping associate and correlate identification of various entities.

The main characteristic of the sensor category 346 is where a data acquisition and communication device 326 is capable of providing environmental or other conditions relative to an asset. This may include data acquisition and communication devices 326 that are capable of sensing and reporting temperature, pressure, force, movement, etc. In an alternative embodiment, the sensor category 346 may be further sub-divided into the following sub-categories: continuous monitoring, event-driven, and queried. The division of these sub-categories is based on how the sensor data is retrieved by the visibility management system 40. The continuous monitoring sub-category refers to a data acquisition and communication device 326 that perform continuous sensing and communicate the data back to the visibility management system 40 on a periodic basis. The event-driven sub-category refers to a data acquisition and communication device 326 that reports data to the visibility management system 40 every time an event occurs, such as the sensing of any deviations or abnormalities. These deviations or abnormalities may be specified by thresholds that are pre-set by the visibility management system 40 based on rules. The queried sub-category refers to a data acquisition and communication device 326 that does not report data to the visibility management system 40 unless queried by the system.

The main characteristic of the time stamping category 348 is where a data acquisition and communication device 326 is capable of time stamping their operations. The operations may include items such as scanning a tag where the device is a RFID reader, or sensing a temperature if the device is a temperature sensor, or tracking location if the device is a GPS receiver. Thus, a data acquisition and communication device 326 that is assigned to this category may also be assigned to another category. The benefit of this category is that this allows the visibility management system 40 to be informed of a time for purposes of correlating events and providing notifications.

The benefit of assigning the data acquisition and communication devices 326 to one or more categories is that the system becomes scalable. In other words, the visibility management system backbone 310 can now work with a finite number of categories as opposed to working with a variety of independent devices that each have different characteristics. This, in turn, facilitates more efficient communications without having to redesign the system when new asset tracking technologies evolve. Thus, functional scalability is achieved in the sense that the system automatically scales to functionally accommodate new asset tracking technologies.

Binding/Unbinding Operations

The asset visibility management system 40 supports data binding and unbinding operations by creating linkage between various attributes of an asset. This allows seamless tracking of assets even when the asset itself is not directly visible. The binding and unbinding operations within the visibility management system 40 will be discussed using the distribution chain described above when an asset moves from an originator facility 50a to a recipient facility 50n.

For purposes of illustration, it will be assumed that the visibility management system 40 comprises of four binding levels—Level 0 (Asset Level); Level 1 (Pallet Level); Level 2 (Container Level); and Level 3 (Vehicle Level). One skilled in the art having the benefit of this disclosure will recognize that aspects of the binding levels, and functions thereof, may be combined, swapped, added, or subtracted. What is important is that each of these binding levels has some relational nature with respect to the type of asset being moved and the various asset carriers available in the distribution chain. The present invention provides a mechanism for tying assets and asset carriers (such as pallets, containers, and vehicles) together to provide an end-to-end solution for asset visibility management. Additionally, as mentioned above, the asset itself may be a component or a product or device. In that case, the present invention may be used to provide a mechanism for tying components of a product to a completed product. For instance, in the case of a cellular phone, the asset may be a component (such as a battery) and the asset carrier may be the cellular phone itself. In this way, an entity desiring visibility at a component level may define an asset in the terms of a battery and an entity desiring visibility at a product level may define the asset at a cellular phone level.

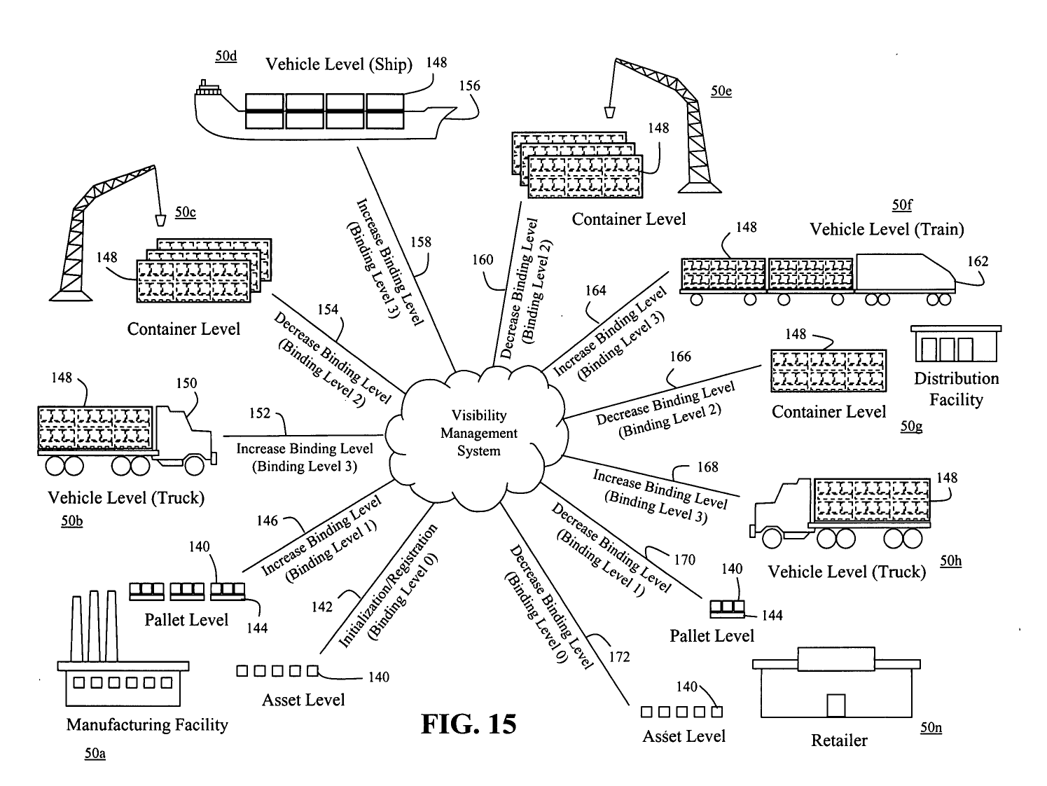

Referring to FIG. 15, when an asset 140 is made or created, the originator facility 50a will register the asset and initialize the asset 140 to the lowest binding level (Level 0). This is shown on link 142 of FIG. 15. If the originator facility 50a places the asset 140 on an asset carrier, such as a pallet 144, the originator facility 50a will increase the binding level to a pallet level (Level 1). This is shown on link 146 of FIG. 15.

In one embodiment, the pallet 144 (holding the asset 140) may then be placed inside another asset carrier, such as a container 148 that is mounted on a truck 150. At this point, the first transport facility 50b will take custody of the asset and increase the binding level to a container level (Level 2) and then to a vehicle level (Level 3). This is shown on link 152 of FIG. 15.

The first transport facility 50b will deliver the container 148 (that holds the pallet 144 and the asset 140) to the first transfer facility 50c. When the first transfer facility 50c takes custody of the container 148, the first transfer facility will decrease the binding level to the container level (Level 2). This is shown on link 154 of FIG. 15.

When available, the first transfer facility 50c transfers the container 148 (that holds the pallet 144 and the asset 140) to another transport means, such as a ship 156, that is owned by a second transport facility 50d. The second transport facility 50d takes custody of the container 148 and will increase the binding level to the vehicle level (Level 3). This is shown on link 158 of FIG. 15.

The second transport facility 50d moves the container 148 (that holds the pallet 144 and the asset 140) from the first transfer facility 50c to the second transfer facility 50e. The second transfer facility 50e takes custody of the container 148 and will decrease the binding level to the container level (Level 2). This is shown on link 160 of FIG. 15.

The second transfer facility 50e may transfer the container 148 (that holds the pallet 144 and the asset 140) to another transport means, such as a train 162, that is owned by a third transport facility 50f. The third transport facility 50f takes custody of the container 148 and will increase the binding level to the vehicle level (Level 3). This is shown on link 164 of FIG. 15.

The third transport facility 50f may move the container 148 (that holds the pallet 144 and the asset 140) from the second transfer facility 50e to a storage facility 50g. The storage facility 50g takes custody of the container 148 and will decrease the binding level to the container level (Level 2). This is shown on link 166 of FIG. 15. The storage facility 50g may hold the container 148 until a fourth transport facility 50h picks up the container 148. The storage facility 50g may also unload the container 148 and move the pallet 144 and/or asset 140 to a different container that is associated with a number of other assets that are intended for the recipient facility 50n. If this occurs, the storage facility 50g may make a number of unbinding and binding operations with respect to the asset that is intended to the recipient facility 50n.

When the fourth transport facility 50h takes custody of the container 148 (that holds the pallet 144 and asset 140), the fourth transport facility 50h will increase the binding level to the vehicle level (Level 3). This is shown on link 168 of FIG. 15.

The fourth transport facility 50h may move the container 148 (that holds the pallet 144 and the asset 140) from the storage facility 50g to the recipient facility 50n. The recipient facility 50n will then take custody of the contents of the container 148 and will decrease the binding level to the pallet level (Level 1). This is shown on link 170 of FIG. 15. When the recipient facility 50n takes the asset 140 off the pallet 144 (for example, when placing it on a store shelf), the recipient facility 50n will decrease the binding level to the asset level (Level 0). This is shown on link 172 of FIG. 15.

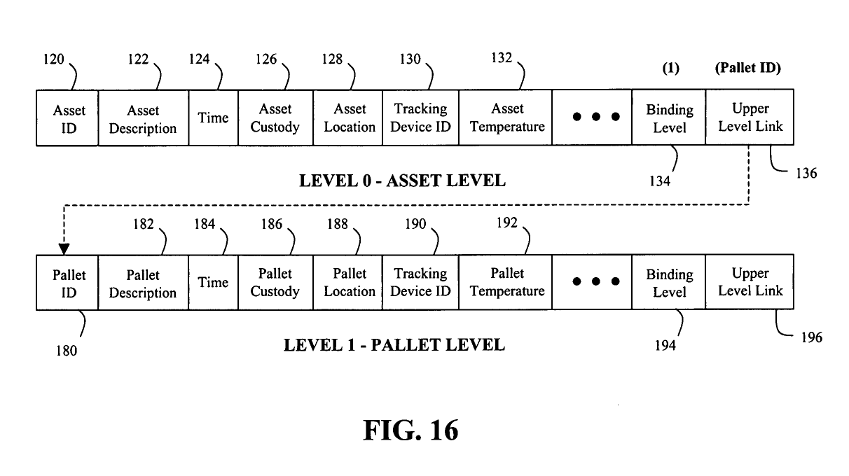

The advantage of the binding and unbinding feature of the present invention is that it creates linkage between an asset and the higher levels of asset carriers (such as the pallet level, container level, and the vehicle level). During the binding process, an identification of the asset is linked to the identification of the asset carrier. This linkage facilitates more dynamic state information about an asset. For example, FIGS. 16-18 illustrate one embodiment of the binding and unbinding of assets according to the present invention.

Referring to FIG. 16, for each registered asset, there may be an association of the asset with a plurality of information elements or fields such as an asset identification 120, an asset description 122, a time 124 that the information elements or fields were last updated, an asset custody identification 126, an asset location 128, a tracking device identification 130, and other environmental conditions, if needed, such as an asset temperature 132. Additionally, in this embodiment, for enhancing functionality, the information elements or fields also includes a binding level 134 and an upper binding level link 136. In further embodiments, the registered asset may include a link or other identification of one or more components that make up the asset. For instance, if the asset was a cellular phone, the data fields may include a link or other identification of the make and model of the cellular phone battery. This would assist in quickly identifying all affected assets in a situation where a particular type of battery is defective and needs to be recalled.

Similarly, for each pallet that may be used to carry assets, there may be a plurality of information elements or fields such as a pallet identification 180, a pallet description 182, a time 184 that the information elements or fields were last updated, a pallet custody identification 186, a pallet location 188, a tracking device identification 190, and other environmental conditions, if needed, such as a pallet temperature 192. In other embodiments, the information elements or fields may also include binding level 194 and upper binding level link 196.

When an asset gets placed onto an asset carrier (such as a pallet), the binding level 134 associated with the asset will increase (level 1). This step will tell any querying proxies that they can also find status information (such as the location of the asset) by looking at the information elements or fields associated with the linked pallet identification. The benefit of this feature is that if the location of the pallet is being tracked independently of the asset, then the location of the asset may be best found by tracking the location of the pallet instead of the asset itself.

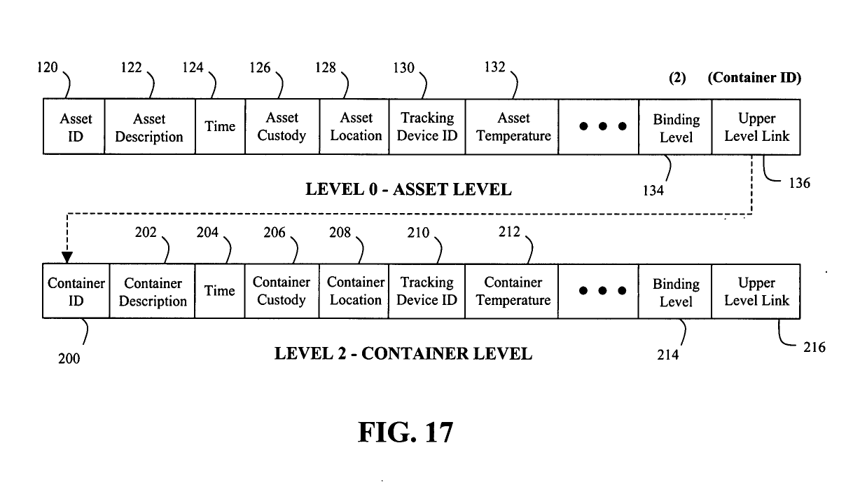

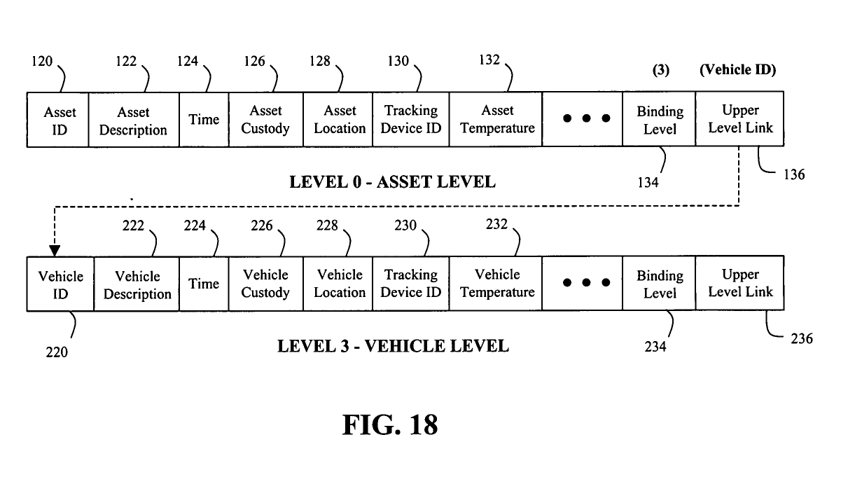

FIGS. 17 and 18 show that there may be a plurality of information or fields associated with other types of carriers, such as a container or a vehicle. Each container may have a container identification 200, a container description 202, a time 204 that the information elements or fields were last updated, a container custody identification 206, a container location 208, a tracking device identification 210, and other environmental conditions, if needed, such as a container temperature 212. In other embodiments, the information elements or fields may also include a binding level 214 and an upper binding level 216.

Each vehicle may have a vehicle identification 220, a vehicle description 222, a time 224 that the information elements or fields were last updated, a vehicle custody identification 226, a vehicle location 228, a tracking device identification 230, and other environmental conditions, if needed, such as a vehicle temperature 232. In other embodiments, the information elements or fields may also include a binding level 234 and an upper binding level 236. Again, the benefit of linking the asset to a container or vehicle is that the location of a container or vehicle may be tracked independently of the asset. Moreover, many transport facilities and storage facilities may not know the exact contents of the assets in a container or vehicle. Linking the assets to the container or vehicle level allows for better tracking of assets and enhances the ability to provide end-to-end asset visibility management.

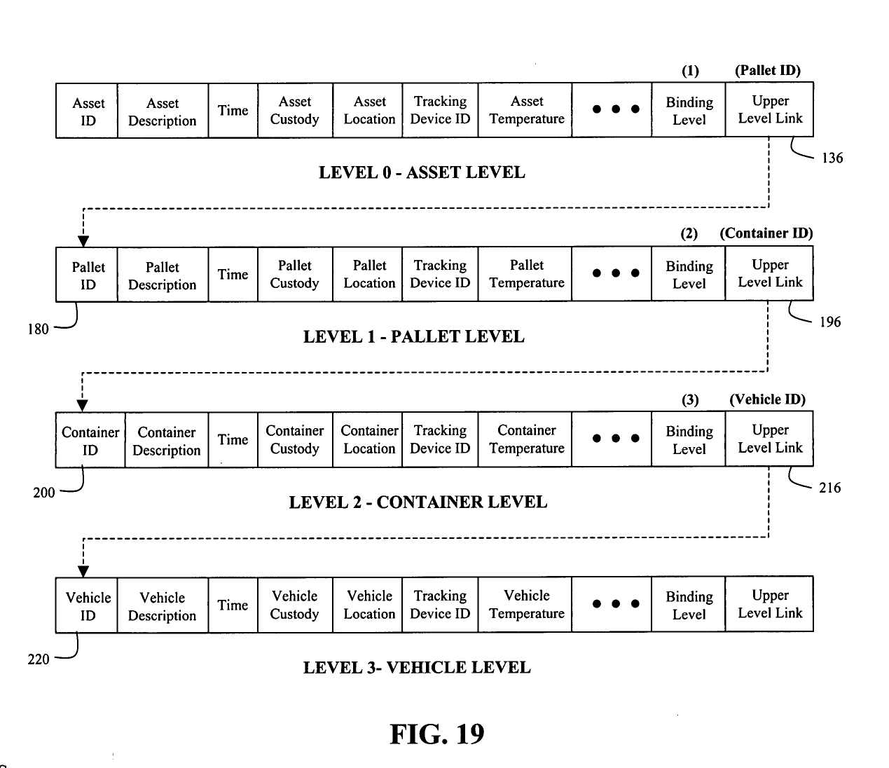

FIG. 19 shows an alternative embodiment where the binding levels associated with various asset carriers can be linked together in a hierarchal fashion. In this case, the asset binding level 136 of an asset is linked to a pallet identification 180. The pallet binding level 196 of the pallet is linked to a container identification 200. The container binding level 216 of the container is linked to a vehicle identification 220. This feature also provides the benefit of allowing a user to access state information directly from an asset carrier when the asset may not be directly visible. Moreover, this type of linkage also enables transport and storage facilities to understand the contents of an asset carrier. This may be important for export and import reasons.

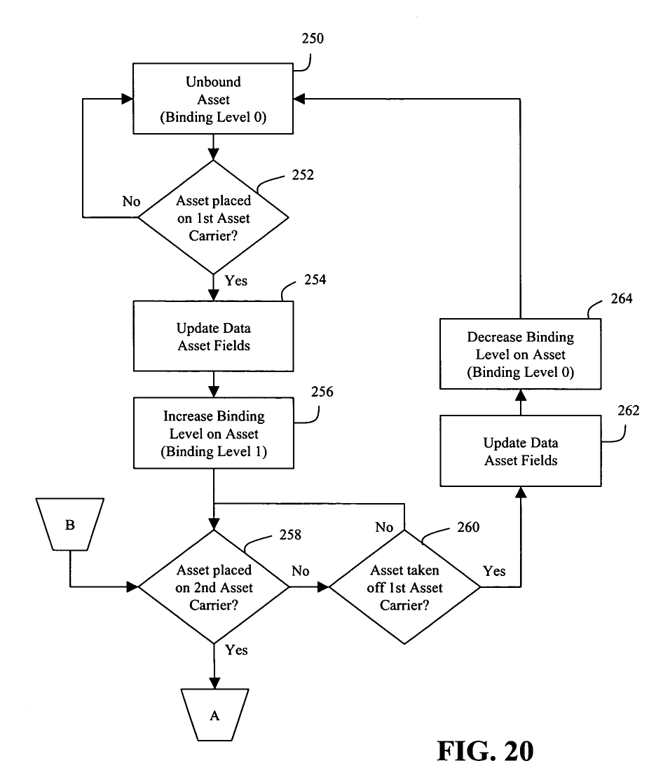

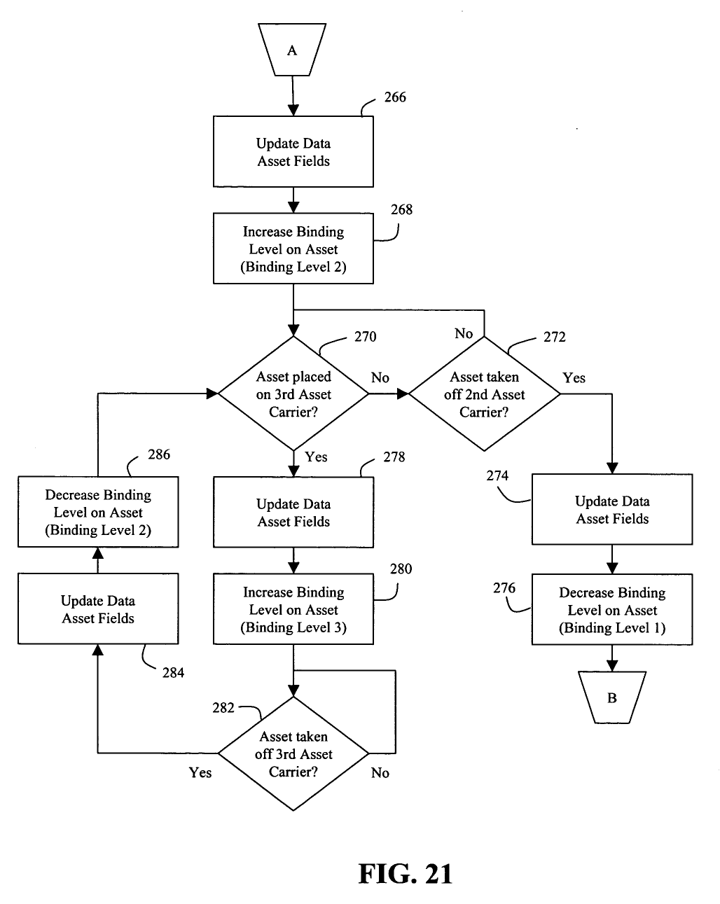

FIGS. 20 and 21 are flow diagrams that show a method of binding and unbinding an asset with higher level carriers (such as a pallet, a container, or a vehicle). FIG. 20 begins at block 250 where an asset is unbound (initialized at binding level 0). At decision block 252, a determination is made whether the asset is being placed on a first asset carrier such as a pallet. If not, the process stays at block 250. However, if the asset is placed on the first asset carrier, the process continues to blocks 254 and 256 where the data fields of the asset are updated, including increasing the binding level of the asset (e.g., to level 1). The process then continues to decision block 258.

At decision block 258, a determination is made whether the asset is being placed on a second asset carrier such as a container. If not, the process will continue to decision block 260 where a determination is a made whether the asset is being taken off the first asset carrier. The process will continue at decision blocks 258 and 260 until the asset is placed onto a second asset carrier or until the asset is taken off the first asset carrier. If the asset is taken off the first asset carrier, then the process continues to blocks 262 and 264 where the data fields of the asset are updated, including decreasing the binding level of the asset (e.g., to level 0). The process will then return to block 250.

If the asset is placed onto a second asset carrier, the process will continue on FIG. 21 at process blocks 266 and 268 where the data fields of the asset are updated, including increasing the binding level of the asset (e.g. to level 2). The process then continues to decision block 270.

At decision block 270, a determination is made whether the asset is being placed on a third asset carrier such as a vehicle. If not, the process will continue to decision block 272 where a determination is a made whether the asset is being taken off the second asset carrier. The process will continue at decision blocks 270 and 272 until the asset is placed onto a third asset carrier or until the asset is taken off the second asset carrier. If the asset is taken off the second asset carrier, then the process continues to blocks 274 and 276 where the data fields of the asset are updated, including decreasing the binding level of the asset (e.g., to level 1). The process may then return to decision block 258.

If the asset is placed onto a third asset carrier, the process will continue to process blocks 278 and 280 where the data fields of the asset are updated, including increasing the binding level of the asset (e.g. to level 3). Assuming there are only 3 levels of asset binding, the process then continues to decision block 282 where a determination is made whether the asset is taken off the third asset carrier. If so, then the process continues to blocks 284 and 286 where the data fields of the asset are updated, including decreasing the binding level of the asset (e.g. to level 2). The process may then return to decision block 270.

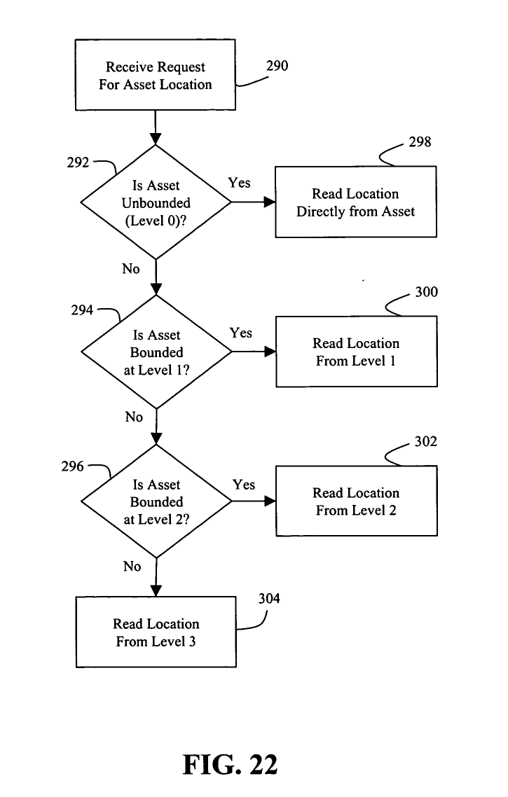

FIG. 22 shows a flow diagram of one embodiment of obtaining state information on an asset where the asset visibility management system 40 includes the binding and unbinding of assets. In block 290, the asset visibility management system 40 will receive a request for that status of an asset (e.g. location of the asset). The process will then continue to decision blocks 292, 294, 296 where a determination is made whether the asset is bounded to a specific binding level. In one embodiment, this determination can be made by accessing the binding level data field associated with the asset. If the asset is not bounded (e.g., level 0), the asset visibility management system 40 may obtain the status of the asset directly from the data fields associated with the asset (block 298). If the asset is bounded at a first level (e.g., level 1), the asset visibility management system 40 may obtain the status of the asset from data fields of the asset carrier associated with the first level (block 300). If the asset is bounded at a second level (e.g., level 2), the asset visibility management system 40 may obtain the status of the asset from data fields of the asset carrier associated with the second level (block 302). If the asset is bounded at a third level (e.g., level 3), the asset visibility management system 40 may obtain the status of the asset from data fields of the asset carrier associated with the third level (block 304).

Event Correlator

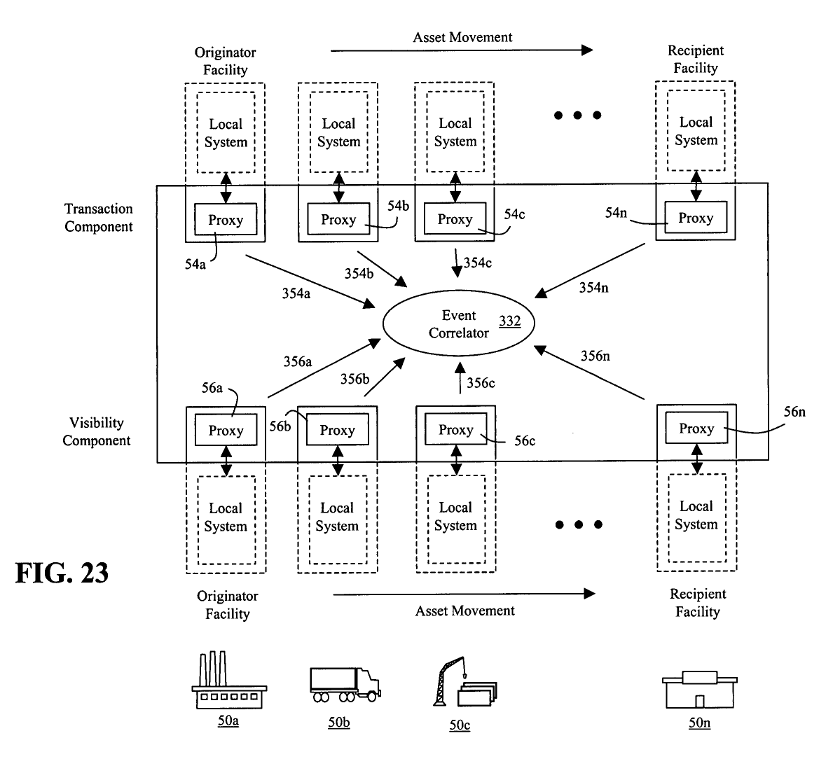

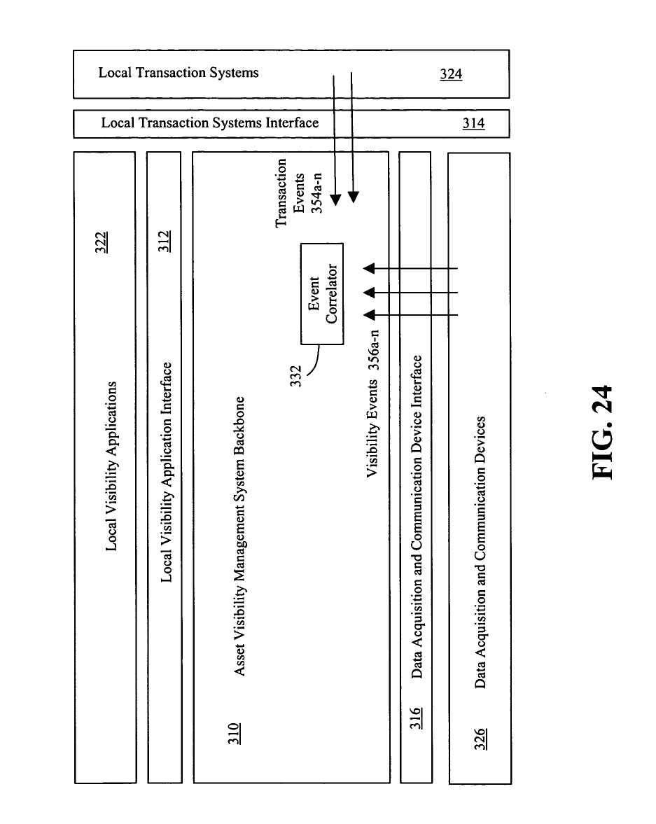

Real time event correlation is another advantageous feature of the present invention. Accordingly, in another embodiment, as illustrated in FIG. 23, the asset visibility management system 40 may further include an event correlator 332 that is configured to communicate with the transactional components 54a-n and the visibility components 56a-n of the proxies 52a-n. As shown in FIG. 24, the event correlator 332 may receive transaction events 354a-n from local transaction systems 324. The types of local transaction systems 324 are described further above. In one embodiment, the transactional components of the proxies may serve as the local transaction systems interface 314. As explained further below, the local transaction systems interface 314 can translate the transaction events in one format from a local asset transaction system 324 into a common communication format for receipt by the event correlator 332.

The event correlator 332 may also receive visibility events 356a-n from local data acquisition and communication devices 326 over the data acquisition and communication device interface 316. These aspects of the system architecture are also described above. In one embodiment, the visibility components of the proxies may serve as the data acquisition and communication device interface 316. As explained further below, the data acquisition and communication device interface 316 can translate the visibility events in one format from a local data acquisition and communication device 326 into a common communication format for receipt by the event correlator 332.

The event correlator 332 of the asset visibility management system 40 filters, translates, aggregates, and correlates real-time events (both visibility events and transaction events) to generate intelligent and condensed information for the business applications and systems. For instance, referring back to FIG. 23, the event correlator 332 is set up to receive transaction events 354a-n from the transaction components 54a-n of the proxies 52a-n and to receive visibility events 356a-n from the visibility components 54a-n of the proxies 52a-n. An example of a transaction event 354a from an originator facility 50a may include the readiness of an asset to be shipped to a recipient facility 50n, an order for an asset carrier (e.g. a container or a vehicle), or the submission of an invoice. An example of a transaction event 354b from a transport facility 50b may include the scheduling of an asset carrier for the originator facility 50a. An example of a transaction event 354c from a transfer facility 50c may include the readiness of an asset carrier to be picked up by another transportation means. An example of a transaction event 354n from a recipient facility may be the placement of an order for an asset.

On the visibility side, an example of a visibility event 356a from an originator facility 50a may include a report from a data acquisition and communication device that an asset has left the originator facility 50a or within a specific location within the facility. An example of a visibility event 356b from a transport facility 50b may include a report from a data acquisition and communication device that an asset (or its asset carrier) is currently at a specific location on a vehicle. An example of a visibility event 356c from a transfer facility 50c or a recipient facility 50n may include a report from a data acquisition and communication device that an asset (or its asset carrier) has entered the transfer facility 50c or a recipient facility 50n.

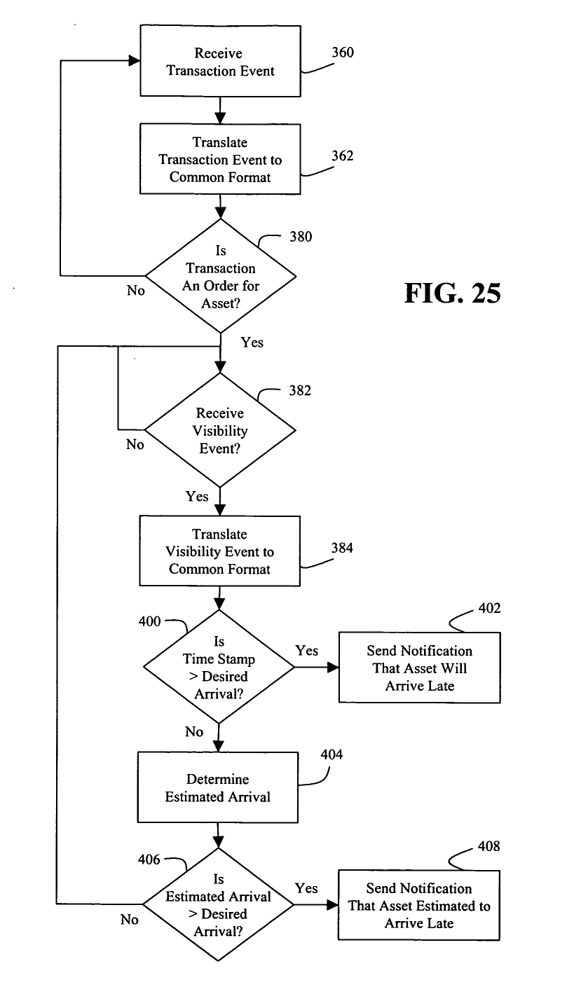

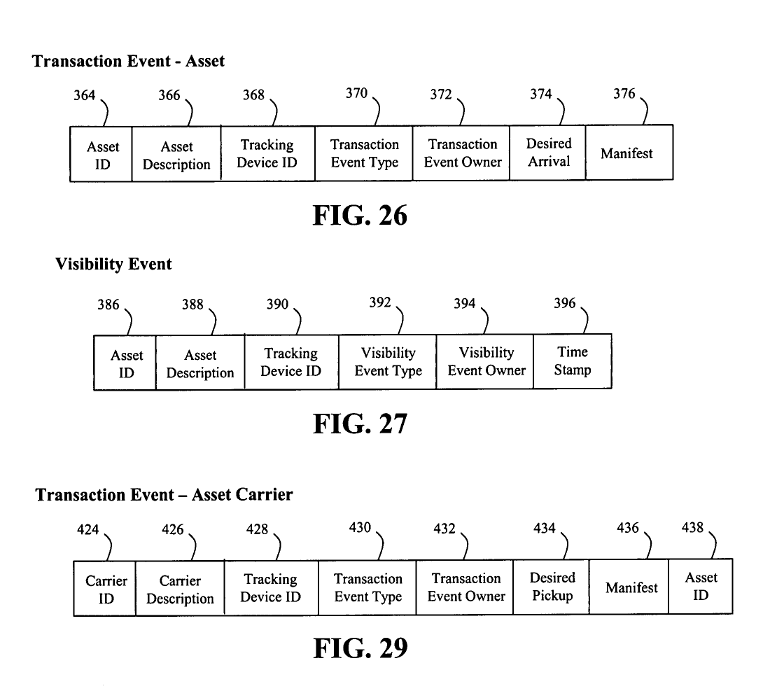

The event correlator 332 receives the transaction events 354a-n and visibility events 356a-n, translates the events to a common format, and correlates the events to provide notifications or to enable corrective action, if needed. Alternatively, the transaction components 54a-n and the visibility components 56a-n of the proxies 52a-n may provide the translation function into a common format and present the events to the event correlator for correlation. In any event, FIG. 25 shows one example of a method of receiving, translating, and correlating events from different types of facilities. Here, the process may begin at block 360 where the event correlator 332 receives a transaction event. Assume for purposes of illustration, that the transaction event 354n is an event that is received from a recipient facility 50n and the event relates to the placement of an order for an asset from an originator facility 50a. In this case, the process may continue to block 362 where the event correlator 332 will translate the transaction event 354n into a common format such as the data fields shown in FIG. 26.

In one embodiment, the common format for the data fields for a translated transaction event 354n may include items such as an asset identification 364, an asset description 366, a tracking identification 368 for the asset, a transaction event type 370, a transaction event owner 372, a desired arrival time 374 of the asset, and a manifest 376 for movement of the asset. Although a specific set of data fields is shown for purposes of illustration, one skilled in the art having the benefit of this disclosure will recognize that aspects of the data fields, and functions thereof, may be combined, swapped, added or subtracted. What is important to note is that the transaction events are translated into a common format so that the event correlator 332 may use the information to correlate the transaction event with other events.

The process may then continue to decision block 380 where a determination is made whether the transaction event has a specific event type. For example, the process may include a determination whether the transaction event is an order of an asset. If the transaction is not an order, the process may return to block 360 to await another transaction event. If the transaction is an order, then the process may continue to decision block 382. At decision block 382, a determination may be made whether the event correlator 332 has received a visibility event from one of the facilities 50a-50n. If not, then the process may continue to wait until a visibility event occurs. When a visibility event occurs, then the process may continue to block 384.

At block 384, the process may include translating a visibility event 354a-n into a common format such as the data fields shown in FIG. 27. As mentioned above, a visibility event 354a from an originator facility 50a may include a report from a data acquisition and communication device that an asset (or an asset carrier) has left the originator facility 50a. A visibility event 356b from a transport facility 50b may include a report from a data acquisition and communication device that an asset (or an asset carrier) is currently at a specific location on a vehicle. A visibility event 356c from a transfer facility 50c or a recipient facility 50n may include a report from a data acquisition and communication device that an asset (or an asset carrier) has entered the transfer facility 50c or a recipient facility 50n.

In one embodiment, the common format for the data fields for a visibility event 356a-n may include items such as an asset identification 386, an asset description 388 (if known), a tracking identification 390 for the asset, a visibility event type 392, a visibility event owner 394, and a time stamp 396 associated with the visibility event. Again, although a specific set of data fields is shown for purposes of illustration, one skilled in the art having the benefit of this disclosure will recognize that aspects of the data fields, and functions thereof, may be combined, swapped, added or subtracted. What is important to note is that the visibility events are translated into a common format so that the event correlator 332 may use the information to correlate the visibility event with other events.

As part of the translation function, the event correlator 332 may need to use binding links between assets and asset carriers to translate a visibility event 356a-n to an asset level for cross-correlation. The binding and unbinding of assets and asset carriers is discussed in the preceding section. For instance, if a visibility event 356b relates to the transport of a container (holding assets) on a vehicle, the binding links established between an asset and its asset carriers (e.g., container and vehicle) may be used to translate a visibility event 356b into a common format for correlation to related transaction events associated with the asset.

In any event, in the case where the transaction event 354n is an order for an asset, the process may further include a decision block 400 that asks whether the time stamp 396 associated with the visibility event is later in time than the desired arrival time 374. If so, the event correlator 332 may send a notification (block 402) to the originator facility 50a, the recipient facility 50n, or any other business or entity that may need to know that the asset will not arrive at the desired arrival time 374. If the time stamp 396 associated with the visibility event is not later in time than the desired arrival time, the process may continue to block 404.

At block 404, the process may include a determination, based on the time stamp 96 associated with the visibility event and the manifest 376 associated with the transaction event, of the estimated arrival time of the asset. The process may then continue to determination block 406 that asks whether the estimated arrival time is later in time than the desired arrival time 374. If so, the event correlator 332 may be configured to send a notification (block 408) to the originator facility 50a, the recipient facility 50n, or any other business or entity that may need to know that the asset may not arrive at the desired arrival time 374. Alternatively, the event correlator 332 may schedule corrective measures to be taken to increase the speed of the asset through the distribution chain (such as modifying the manifest 376 associated with the asset). If the estimated arrival time is not later than the desired arrival time 374, then the process may continue back to decision block 382 where the process may wait for another visibility event to process.

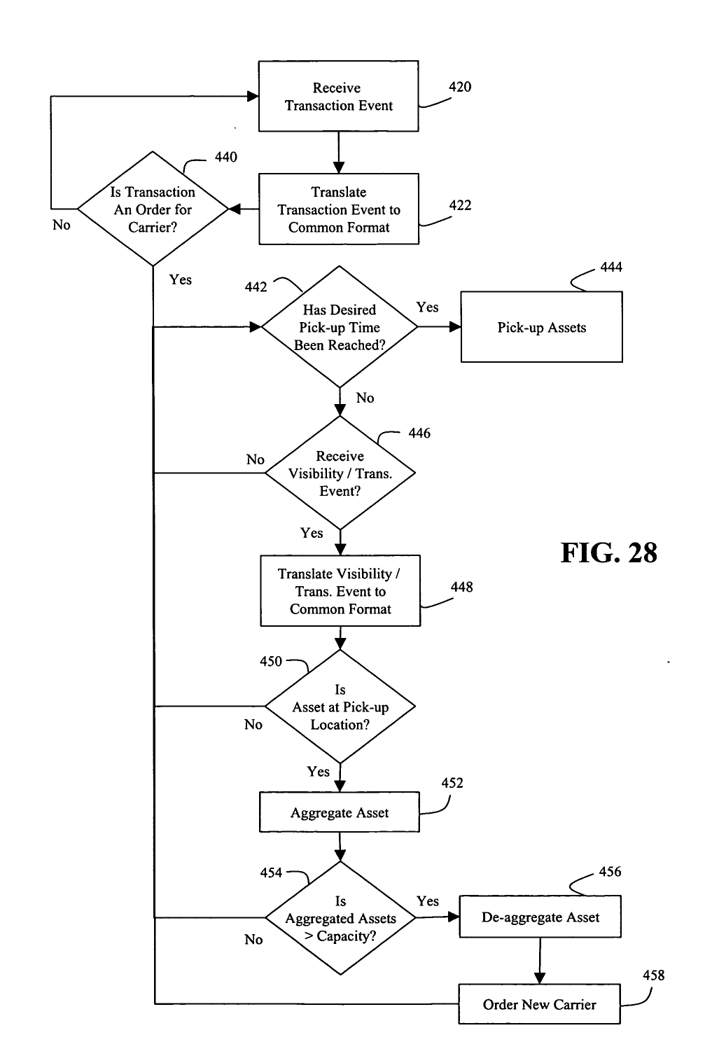

To further illustrate the functions of the event correlator, FIG. 28 shows another method of receiving, translating, and correlating events between different facilities. The method in FIG. 25 was associated with a transaction event relating to an order of an asset by a recipient facility 50n from an originator facility 50a. The method in FIG. 28 is associated with a transaction event relating to an order for an asset carrier for transporting assets between facilities such as between an originator facility 50a and a transfer facility 50c.

In FIG. 28, the process may begin at block 420 where the event correlator 332 receives a transaction event. As mentioned above, assume for purposes of illustration, the transaction event 354a may be an event that relates to the placement of an order for an asset carrier from a transport facility 50b. In this case, the process may continue to block 422 where the event correlator 332 will translate the transaction event 354a into a common format such as the data fields shown in FIG. 29.

In one embodiment, the common format for the data fields for a translated transaction event 354a may include items such as a carrier identification 424, a carrier description 426, a tracking identification 428 for the carrier, a transaction event type 430, a transaction event owner 432, a desired pick-up time 434 for the asset carrier of the asset, a manifest 436 for movement of the carrier, and/or an asset identification 438. Although a specific set of data fields is shown for purposes of illustration, one skilled in the art having the benefit of this disclosure will recognize that aspects of the data fields, and functions thereof, may be combined, swapped, added or subtracted. What is important to note is that the transaction events are translated into a common format so that the event correlator 332 may use the information to correlate the transaction event with other events.

The process may then continue to decision block 440 where a determination is made whether the transaction event has a specific event type. For example, the process may include a determination whether the transaction event is an order of an asset carrier. If the transaction is not an order, the process may return to block 420 to await another transaction event. If the transaction is an order, then the process may continue to decision block 442. At decision block 442, a determination may be made whether the desired pick-up time 434 for the asset carrier has been reached. If so, then the assets that need to be picked-up by the asset carrier are picked-up (block 444). Additionally, as mentioned above, this step may also include binding the information elements associated with an asset with the information elements associated with an asset carrier. If desired pick-up time 434 for the asset carrier has not been reached, then the process may continue to decision block 446.

At decision block 446, a determination may be made whether the event correlator 332 has received a visibility or a transaction event from one of the facilities 50a-50n associated with the asset carrier. If not, then the process may continue to back to decision block 442. When a visibility event occurs, then the process may continue to block 448.

At block 448, the process may include the event correlator 332 translating the visibility or transaction event into a common format such as the data fields shown in FIGS. 25, 26, or 28. A visibility event may include a report from a data acquisition and communication device that an asset is at was “seen” at the originator facility 50a. A transaction event may relate to another order for an asset carrier for transporting assets between facilities.

In the case where the original transaction event is an order for an asset carrier, the process may further include a decision block 450 that asks whether the asset associated with the order is at the pick-up location scheduled for the asset carrier. If not, the process may proceed back to decision block 442. If the asset associated with the order is at the pick-up location scheduled for the asset carrier, the event correlator 332 may aggregate the asset with other assets already scheduled for the asset carrier (block 452) to determine if the aggregated assets for the asset carrier exceeds the asset carrier's capacity. The asset carrier's capacity may be included in the carrier description 426. This determination may be made at decision block 454.

If the aggregated assets associated with the asset carrier do not exceed the carrier's capacity, the process may proceed back to decision block 442. If the aggregated assets associated with the asset carrier does exceed the carrier's capacity the process may proceed to process blocks 456 and 458 where the asset associated with the new visibility or transaction event is de-aggregated from the asset carrier and a new asset carrier is ordered.

As can be seen from the above, the event correlation function of the present invention helps correlate the business transaction events and the visibility events across different business entities and domains. This feature improves communications between different business entities and helps the business entities to operate with improved efficiency.

Rules Engine

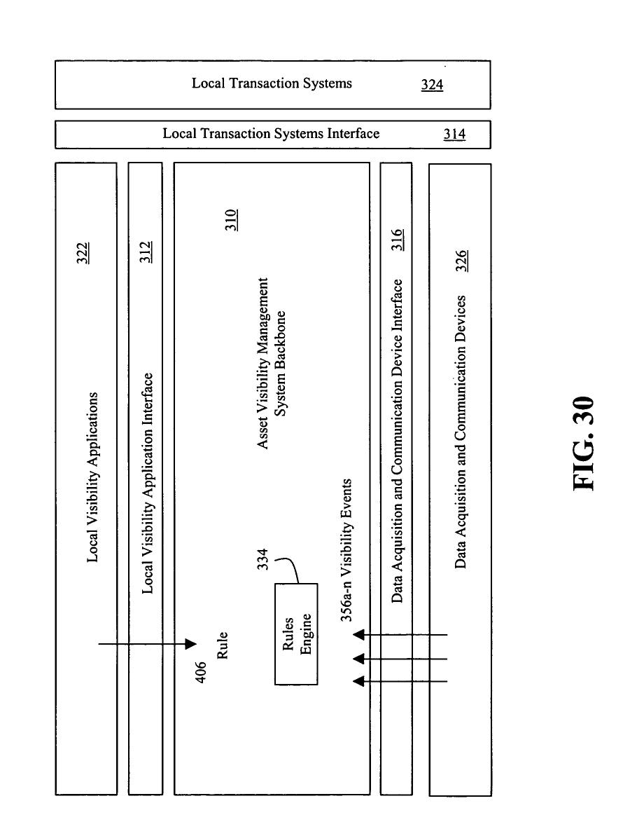

Real time event processing is another advantageous feature of the present invention. As described above, there may be multiple and independent business facilities that are involved in moving an asset from an originator facility 50a to a recipient facility 50n. The benefit of the present invention is that it facilitates better communications between independent facilities to escalate issues to a facility when needed. Accordingly, in one embodiment as shown in FIG. 30, the asset visibility management system 40 further includes a rules engine 334 that is configured to communicate with local business applications and systems. For instance, the rules engine 334 may receive rules 460 (or rule specifications and criteria) that are translated over a local visibility application interface 312 from local visibility applications 322. Types of local visibility applications 322 are described further above. In one embodiment, the local visibility application interface 312 can translate rules, specifications, and criteria in one format from a local visibility application 322 into a common communication format for receipt by the rules engine 334.

The rules engine 334 may also receive visibility events 356a-n from local data acquisition and communication devices 326 over the data acquisition and communication device interface 316. These aspects of the system architecture are also described above. In one embodiment, the visibility components of the proxies may serve as the data acquisition and communication device interface 316. As explained further below, the data acquisition and communication device interface 316 can translate the visibility events in one format from a local data acquisition and communication device 326 into a common communication format for receipt by the rules engine 334.

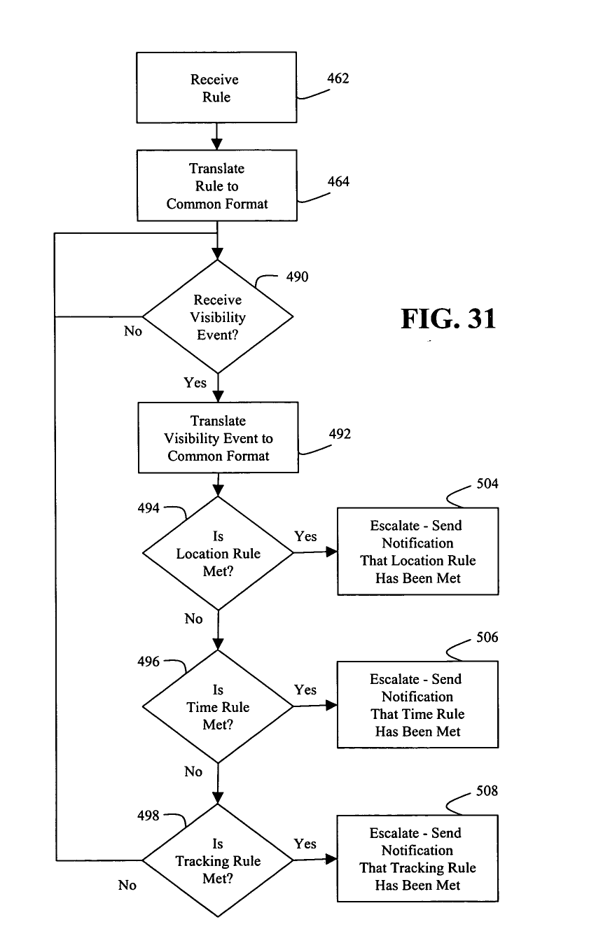

The rules engine 334 may be located at a central service facility or may be included as a component in each proxy 52a-n. As explained below, the rules engine 334 may be specifically configured by one of the independent facilities based on the needs of that facility. For example, FIG. 31 illustrates a flow diagram of one embodiment of a method for using the rules engine 334 of the present invention. The process may begin at block 462 where visibility management system 40 receives a rule 460 or other specification. In block 464, the rule 460 may then be translated into a common format for use by the rules engine 334.

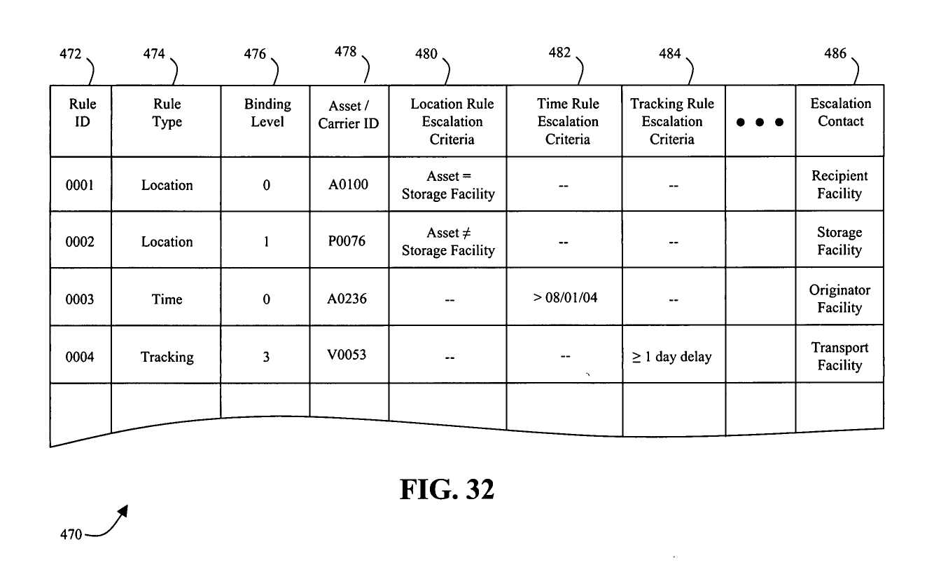

For instance, FIG. 32 shows one embodiment of a database 470 that may be used by the rules engine 334 to process any rules specified by a facility 50a-n. In one embodiment, the database 470 has a rule identification 472, a rule type 474, a binding level 476, an asset or asset carrier identification 478, rule escalation criteria 480, 482, 484, and an escalation contact 486. The escalation contact 486 may identify a facility or party who needs to be notified when rule criteria is met. Although a specific set of data fields is shown for purposes of illustration, one skilled in the art having the benefit of this disclosure will recognize that aspects of the data fields, and functions thereof, may be combined, swapped, added or subtracted. What is important to note is that the rule specifications are translated into a common format so that the rules engine 334 may use the information to determine whether any rule criteria has been met.

FIG. 32 also illustrates the different types of rules that may be specified by a facility or user. For instance, a location type rule (such as rule identification 0001) may relate to a recipient facility's 50n desire to be notified when an asset (at binding level 0) reaches a certain storage facility. A location type rule (such as rule identification 0002) may relate to a storage facility's 50g desire to be notified when a pallet (at binding level 1) leaves the storage facility. Additionally, a time type rule (such as rule identification 0003) may relate to an originator facility's 50a desire to be notified when a specific asset (at binding level 1) is found within a facility after a specified date. And, a tracking type rule (such as rule identification 0004) may relate to a transport facility's 50b desire to be notified when a vehicle is more than 1 day late. Although many types of rules may be further added to the database 470, it should be recognized that the format herein enables a variety of types of rules to be specified by a business that can be tied directly into real-time or near real-time visibility events across an entire distribution chain.

Accordingly, at decision block 490, a determination may be made whether the rules engine 334 has received a visibility event from one of the facilities 50a-50n. If not, then the process may continue to wait until a visibility event occurs. When a visibility event occurs, then the process may continue to block 492.

At block 492, the process may include translating a visibility event 354a-n into a common format such as the data fields shown in FIG. 27. As mentioned above, a visibility event 354a from an originator facility 50a may include a report from a data acquisition and communication device that an asset (or an asset carrier) has left the originator facility 50a. A visibility event 356b from a transport facility 50b may include a report from a data acquisition and communication device that an asset (or an asset carrier) is currently at a specific location on a vehicle. A visibility event 356c from a transfer facility 50c or a recipient facility 50n may include a report from a data acquisition and communication device that an asset (or an asset carrier) has entered the transfer facility 50c or a recipient facility 50n.

As part of the translation function, the rules engine 334 may need to use binding links between assets and asset carriers to translate a visibility event 356a-n to an asset level for cross-correlation. The binding and unbinding of assets and asset carriers is discussed in the preceding section. For instance, if a visibility event 356b relates to the transport of a container (holding assets) on a vehicle, the binding links established between an asset and its asset carriers (e.g., container and vehicle) may be used to translate a visibility event 356b into a common format for comparison to any related rules associated with the asset.

In any event, in the case where a specific set of rule types are used (such as a location rule, a time rule, or a tacking rule), the process may further include a series of decision blocks 494, 496, 498 that ask whether the criteria for a specific rule has been met. If so, the rules engine 334 may generate and send a notification (blocks 504, 506, 508) to the contact specified in the escalation contact data field 486.

What has been described is a visibility management system that allows for the management and visibility of the assets across different domains. The system allows a user to seamlessly manage and monitor assets across different domains. The above description of the present invention is intended to be exemplary only and is not intended to limit the scope of any patent issuing from this application. The present invention is intended to be limited only by the scope and spirit of the following claims.

What is claimed is:

1. An asset visibility management system comprising:
a visibility application interface that provides communication between one of a plurality of visibility applications and a common communication format;
an asset data acquisition and communication device interface that provides communication between a plurality of data acquisition and communication devices and the common communication format; and
a rules engine that receives a rule criteria from the visibility application interface in the common communication format and receives visibility events from the asset data acquisition and communication device interface in the common communication format;
wherein rules engine use the received visibility events to determine whether the rule criteria has been satisfied.

2. The asset visibility management system in claim 1 wherein the rule criteria received by the rules engine relates to a determination whether an asset or asset carrier is within a specific location.

3. The asset visibility management system in claim 2 wherein the visibility events received by the rules engine includes a report from a data acquisition and communication device that includes a location of the asset or asset carrier.

4. The asset visibility management system in claim 3 wherein the rules engine sends a notification if the asset or asset carrier is within the specific location.

5. The asset visibility management system in claim 1 wherein the rule criteria received by the rules engine relates to a determination whether an asset or asset carrier has left a specific location.

6. The asset visibility management system in claim 5 wherein the rules engine sends a notification if the asset or asset carrier has left a specific location.

7. The asset visibility management system in claim 1 wherein the rule criteria received by the rules engine relates to a determination whether an asset or asset carrier is found after a specified time.

8. The asset visibility management system in claim 5 wherein the rules engine sends a notification if the asset or asset carrier is found after the specified time.

9. The asset visibility management system in claim 1 wherein the rule criteria received by the rules engine relates to a determination whether an actual arrival time of an asset or asset carrier is later than a desired arrival time.

10. The asset visibility management system in claim 5 wherein the rules engine sends a notification if the actual arrival time of the asset or asset carrier is later than the desired arrival time.

11. An asset visibility management system comprising:
a first interface that translates a rule criteria in a first format from a visibility application into a common communication format;
a second interface that translates a visibility event in a second format from a data acquisition and communication device into the common communication format; and
a rules engine that receives the rule criteria and the visibility event in the common communication format and determines whether the rule criteria has been satisfied.

12. The asset visibility management system in claim 11 wherein the rule criteria received by the rules engine relates to a determination whether an asset or asset carrier is within a specific location.

13. The asset visibility management system in claim 12 wherein the visibility events received by the rules engine includes a report from a data acquisition and communication device that includes a location of the asset or asset carrier.

14. The asset visibility management system in claim 13 wherein the rules engine sends a notification if the asset or asset carrier is within the specific location.

15. The asset visibility management system in claim 11 wherein the rule criteria received by the rules engine relates to a determination whether an asset or asset carrier has left a specific location.

16. The asset visibility management system in claim 15 wherein the rules engine sends a notification if the asset or asset carrier has left a specific location.

17. The asset visibility management system in claim 11 wherein the rule criteria received by the rules engine relates to a determination whether an asset or asset carrier is found after a specified time.

18. The asset visibility management system in claim 15 wherein the rules engine sends a notification if the asset or asset carrier is found after the specified time.

19. The asset visibility management system in claim 11 wherein the rule criteria received by the rules engine relates to a determination whether an actual arrival time of an asset or asset carrier is later than a desired arrival time.

20. The asset visibility management system in claim 15 wherein the rules engine sends a notification if the actual arrival time of the asset or asset carrier is later than the desired arrival time.

21. A method in an asset visibility management system for processing at least one rule criteria, the method comprising:
translating the rule criteria in a first format associated with a visibility application operated by a first business entity into a common communication format;
translating a visibility event in a second format associated with a data acquisition and communication device operated by a second business entity into the common communication format, the first business entity being different from the second business entity; and
determining whether the rule criteria has been satisfied based on the translated visibility event.

22. The method in claim 21 wherein the translated rule criteria relates to a determination whether an asset or asset carrier is within a specific location.

23. The method in claim 22 wherein the translated visibility event includes a report from the data acquisition and communication device that includes a location of the asset or asset carrier.

24. The method in claim 23 further comprising the step of sending a notification if it is determined that the rule criteria has been satisfied.

25. The method in claim 21 wherein the rule criteria relates to a determination whether an asset or asset carrier has left a specific location.

26. The method in claim 25 further comprising the step of sending a notification if it is determined that the rule criteria has been satisfied.

27. The method in claim 21 wherein the rule criteria relates to a determination whether an asset or asset carrier is found after a specified time.

28. The method in claim 27 further comprising the step of sending a notification if it is determined that the rule criteria has been satisfied.

29. The method in claim 21 wherein the rule criteria relates to a determination whether an actual arrival time of an asset or asset carrier is later than a desired arrival time.

30. The method in claim 29 further comprising the step of sending a notification if it is determined that the rule criteria has been satisfied.
